(19) United States
(12) Patent Application Publication
(10) Pub. No.: US 2017/0151802 A1
(43) Pub. Date: Jun. 1, 2017

(54) LIQUID SUPPLY UNIT

(71) Applicant: SEIKO EPSON CORPORATION, Tokyo (JP)

(72) Inventors: Koichi TOBA, Shiojiri-Shi (JP); Taku ISHIZAWA, Matsumoto-shi (JP); Atsuhi KOBAYASHI, Matsumoto-shi (JP); Shun OYA, Kiso-machi (JP); Takumi NAGASHIMA, Matsumoto-shi (JP)

(73) Assignee: SEIKO EPSON CORPORATION, Tokyo (JP)

(21) Appl. No.: 15/360,781

(22) Filed: Nov. 23, 2016

(30) Foreign Application Priority Data
Nov. 27, 2015 (JP) 2015-231544

(51) Int. Cl. B41J 2/175

(52) U.S. Cl. CPC B41J 2/17553; B41J 2/17596

(57) ABSTRACT

A liquid supply unit includes a first wall, a second wall that opposes the first wall, a third wall that intersects the first wall and the second wall, a fourth wall that intersects the second wall and opposes the third wall, a fifth wall that intersects the first wall, the second wall, the third wall, and the fourth wall, a sixth wall that intersects the first wall, the second wall, the third wall, and the fourth wall, and opposes the fifth wall, and a seventh wall that intersects the fifth wall and the sixth wall and is located between the first wall and the fourth wall. The direction from the third wall toward the fourth wall is a direction parallel to a moving direction in which the carriage moves back and forth. The seventh wall inclines relative to the gravity direction toward the third wall side.

### BACKGROUND

1. Technical Field

The present invention relates to liquid supply units.

2. Related Art

Ink cartridges are known as a form of liquid supply unit. An ink cartridge is mounted in a holder of a carriage provided in an inkjet printer (hereinafter simply called a “printer”), which is a form of liquid ejection apparatus, and supplies ink to a print head in the printer (e.g. JP-A-2013-141804). The type of printer in which ink cartridges are mounted in the carriage is also called an on-carriage type.

In the printer of the on-carriage type, when printing is executed, ink in the ink cartridges shakes due to the movement of the carriage. The ink in the ink cartridge is unevenly distributed due to such shaking thereof, which may cause a failure in ink supply to the printer in some cases.

In some kinds of ink cartridge, pigment ink is contained. If an ink cartridge that contains pigment ink stands still for a long period of time, there is a possibility that dye in the pigment ink settles and the density distribution of the pigment ink becomes uneven. For this reason, it is desirable that the cartridge that contains pigment ink is configured to cause shaking of the ink such that the pigment in the pigment ink is effectively stirred when the carriage moves.

Thus, there is room for improvement in the shaking state of the ink when the carriage moves in the ink cartridge mounted in the printer of the on-carriage type.

### SUMMARY

The invention has been made to solve at least a part of the foregoing problem in not only an ink cartridge to be mounted in a carriage in a printer but at least a liquid supply unit to be mounted in a carriage in a liquid ejection apparatus, and can be achieved in the following modes.

[1] In a first mode of the invention, a liquid supply unit is provided. This liquid supply unit may be mounted in a carriage configured to move back and forth in a liquid ejection apparatus, and may include a liquid containing portion, a liquid supply portion, and a plurality of walls. The liquid containing portion may contain liquid to be supplied to the liquid ejection apparatus. The liquid supply portion may be provided for supplying the liquid in the liquid containing portion to the liquid ejection apparatus. The plurality of walls may surround the liquid containing portion. The plurality of walls may include at least a first wall, a second wall, a third wall, a fourth wall, a fifth wall, a sixth wall, and a seventh wall. The first wall may be provided with the liquid supply portion. The second wall may oppose the first wall. The third wall may intersect the first wall and the second wall. The fourth wall may intersect the second wall and oppose the third wall. The fifth wall may intersect the first wall, the second wall, the third wall, and the fourth wall. The sixth wall may intersect the first wall, the second wall, the third wall, and the fourth wall, and oppose the fifth wall. The seventh wall may intersect the fifth wall and the sixth wall, and be located between the first wall and the fourth wall. When the liquid supply unit is mounted in the carriage, a direction from the third wall toward the fourth wall may be a direction parallel to a moving direction in which the carriage moves back and forth. When the liquid supply unit is mounted in the carriage, the seventh wall may incline relative to a gravity direction such that a lower end of the seventh wall is located between the third wall and the fourth wall in the moving direction. With the liquid supply unit in this mode, the liquid that has been unevenly distributed to the fourth wall side in the liquid containing portion due to the movement of the carriage is guided by the seventh wall toward the liquid supply portion provided in the first wall. Accordingly, the occurrence of a failure in liquid supply due to swinging of the liquid in the liquid supply unit is suppressed.

[2] In the liquid supply unit in the above mode, the lower end of the seventh wall may be coupled to the first wall. With the liquid supply unit in this mode, the distance between the seventh wall and the liquid supply portion can be shortened, and liquid that has been unevenly distributed to the fourth wall side can be more quickly guided toward the liquid supply portion.

[3] In the liquid supply unit in the above mode, an inclined inner wall face that inclines relative to the gravity direction may be provided at a corner of the liquid containing portion at which the first wall and the third wall intersect each other, such that a lower end of the inclined inner wall face is located between the third wall and the fourth wall in the moving direction when the liquid supply unit is mounted in the carriage. With the liquid supply unit in this mode, liquid that has been unevenly distributed to the third wall side in the liquid containing portion due to the movement of the carriage is also guided toward the liquid supply portion by the inclined inner wall face provided at the corner between the first wall and the third wall. Accordingly, the occurrence of a failure in liquid supply to the liquid ejection apparatus is further suppressed.

[4] In the liquid supply unit in the above mode, a recess and a projection may be formed on an inner wall face of the seventh wall on the liquid containing portion side. With the liquid supply unit in this mode, the liquid in the liquid containing portion moving upward along the inner wall face of the seventh wall due to the movement of the carriage is suppressed by the recess and projection. In addition, the liquid that has moved upward along the inner wall face is quickly guided toward the liquid supply portion along the inner wall face. Accordingly, the occurrence of a failure in liquid supply to the liquid ejection apparatus is further suppressed.

[5] In the liquid supply unit in the above mode, the seventh wall may have an inclined wall face that is an inner wall face on the liquid containing portion side, when the liquid supply unit is mounted in the carriage, the inclined wall face may incline relative to the gravity direction such that a lower end of the inclined wall face is located between the third wall and the fourth wall in the moving direction, the liquid may be dispersion liquid in which particles that are insoluble in a solvent are dispersed, and the liquid containing portion may have a region that faces the seventh wall and in which the dispersion liquid is contained in a swingable state. With the liquid supply unit in this mode, the occurrence of a liquid supply failure is suppressed by the seventh wall. In addition, the effect of stirring the liquid in the liquid containing portion when the carriage moves is enhanced. Thus, settlement of particles in the liquid is suppressed.

[6] In the liquid supply unit in the above mode, the first wall may have a bottom wall face that faces the liquid containing portion, and the inclined wall face and the bottom wall face may intersect each other via a curved face that is formed by rounding out a corner where the inclined wall face and the bottom wall face intersect each other. With the liquid supply unit in this mode, the effect of stirring the liquid in the liquid containing portion when the carriage moves can be further enhanced.

[7] In the liquid supply unit in the above mode, the first wall may have a bottom wall face that faces the liquid containing portion, the fourth wall may have a side wall face that faces the liquid containing portion, and an angle between the bottom wall face and the inclined wall face on the liquid containing portion side may be larger than an angle between the side wall face and the inclined wall face on the liquid containing portion side. With the liquid supply unit in this mode, when the liquid swings due to the movement of the carriage, an upward movement of the liquid along the inclined wall face is promoted. Therefore, the liquid stirring effect is further enhanced.

[8] In the liquid supply unit in the above mode, the first wall may have a bottom wall face that faces the liquid containing portion, and an angle between the bottom wall face and the inclined wall face on the liquid containing portion side may be 110° or greater and 150° or smaller. With the liquid supply unit in this mode, when the carriage moves, a stirring force capable of increasing dispersibility of the particles in the liquid can be generated in the liquid containing portion.

[9] In the liquid supply unit in the above mode, an angle between the first wall and the seventh wall on the liquid containing portion side may be 130° or greater and 140° or smaller. With the liquid supply unit in this mode, when the carriage moves, a larger stirring force can be generated in the liquid containing portion.

[10] In the liquid supply unit in the above mode, a contact portion that comes into electrical contact with an electrode portion in the liquid ejection apparatus may be arranged on an outer wall face of the seventh wall. With the liquid supply unit in this mode, electrical connectivity to the liquid ejection apparatus is enhanced.

[11] The liquid supply unit in the above mode may further include: a flexible film member located between the fifth wall and the sixth wall; a plate-like member that is located between the fifth wall and the flexible film member to constitute a part of an inner wall face of the liquid containing portion, and is held by the flexible film member so as to be displaced between the fifth wall and the sixth wall in a direction in which the fifth wall and the sixth wall oppose each other, in accordance with internal pressure in the liquid containing portion; and a biasing member that is arranged in the liquid containing portion and biases the plate-like member in a direction from the fifth wall toward the sixth wall. With the liquid supply unit in this mode, the plate-like member is biased in a direction that intersects the carriage moving direction. Therefore, an elastic movement of the plate-like member being affected by the inertia force generated by the movement of the carriage is suppressed. Accordingly, the pressure state in the liquid containing portion generated due to the plate-like member being biased is appropriately maintained.

[12] The liquid supply unit in the above mode may further include a partition wall that is provided between the third wall and the fourth wall, and partitions the liquid containing portion into a first region located on the third wall side and including the liquid supply portion, and a second region located on the fourth wall side and facing the seventh wall, wherein the first region and the second region may be in communication with each other, a liquid containing member that is impregnated with the liquid may be arranged in the first region, and the liquid may be contained in a swingable state in the second region. With the liquid supply unit in this mode, the occurrence of a liquid supply failure is suppressed by the liquid containing member arranged in the first region.

[13] The liquid supply unit in the above mode may further include an atmosphere introduction portion that introduces outside atmosphere into the liquid containing portion, wherein the atmosphere introduction portion may have an atmosphere path through which the atmosphere is distributed, and an atmosphere valve that opens and closes the atmosphere path in accordance with pressure in the liquid containing portion, the atmosphere valve may have a valve seat and a valve member, the valve member may have a valve that moves to a position at which the valve abuts against the valve seat and a position at which the valve is separate from the valve seat, the valve member may be configured such that the valve abuts against the valve seat to close the atmosphere path when the pressure in the liquid containing portion is greater than or equal to a given pressure, and the valve separates from the valve seat to open the atmosphere path when the pressure in the liquid containing portion has become lower than the given pressure, and a moving direction of the valve may be a direction parallel to a direction from the fifth wall toward the sixth wall. With the liquid supply unit in this mode, the movement of the valve being affected by the inertia force generated by the movement of the carriage is suppressed. Therefore, a change in pressure in the liquid containing portion due to the influence of inertia force is suppressed. In particular, in the case where the valve is configured to move using the inertia force, e.g. in the case where the valve is made of an elastic material, the influence of the aforementioned inertia force on the elastic force is suppressed, which is more effective.

Not all of the plurality of constituent elements provided in the above respective modes of the invention are essential. Some of the plurality of constituent elements may be modified, removed, or replaced with other new constituent elements, or the limitations may be partially removed as appropriate, in order to solve a part of or the entire problem described above or in order to achieve some or all of the effects described in this specification. To solve a part of or the entire foregoing problem, or to achieve some or all of the effects described in this specification, some or all of the technical features included in one of the above modes of the invention may be combined with some or all of the technical features included in another mode of the invention to make an independent mode of the invention.

The invention can also be achieved in various modes other than a liquid supply unit. For example, the invention can be achieved in modes such as a liquid ejection apparatus and a liquid ejection system that include a liquid supply unit, and a liquid containing structure in a liquid ejection apparatus.

### BRIEF DESCRIPTION OF THE DRAWINGS

The invention will be described with reference to the accompanying drawings, wherein like numbers reference like elements.

FIG. 1 is a schematic perspective view of a printer according to a first embodiment.

FIG. 2 is a schematic perspective view showing a configuration of a holder provided in a carriage according to the first embodiment.

FIG. 3 is a schematic perspective view of the front side of a cartridge according to the first embodiment as viewed obliquely from above.

FIG. 4 is a schematic perspective view of the back side of the cartridge according to the first embodiment as viewed obliquely from below.

FIG. 5 is a schematic front view of the cartridge according to the first embodiment.

FIG. 6 is a schematic right side face view of the cartridge according to the first embodiment.

FIG. 7 is a schematic bottom view of the cartridge according to the first embodiment.

FIG. 8 is an exploded schematic perspective view of the cartridge according to the first embodiment.

FIG. 9 is a schematic cross-sectional view of the cartridge according to the first embodiment.

FIGS. 10A to 10C are schematic views for illustrating an air intake mechanism in the cartridge in the first embodiment.

FIG. 11 is a schematic view showing a process of mounting the cartridge into the carriage according to the first embodiment.

FIG. 12 is a schematic view for illustrating an effect of suppressing an ink supply failure in the cartridge according to the first embodiment.

FIG. 13 is a schematic cross-sectional view showing a configuration of a cartridge according to a second embodiment.

FIG. 14 is a schematic cross-sectional view showing a configuration of a cartridge according to a third embodiment.

FIG. 15 is a schematic cross-sectional view showing a configuration of a cartridge according to a fourth embodiment.

FIG. 16 is a schematic cross-sectional view showing another exemplary configuration of the cartridge according to the fourth embodiment.

FIG. 17 is a schematic cross-sectional view showing a configuration of a cartridge according to a fifth embodiment.

FIG. 18 is a schematic cross-sectional view showing a configuration of a cartridge according to a sixth embodiment.

FIG. 19 is a schematic cross-sectional view showing a configuration of a cartridge according to a seventh embodiment.

FIG. 20 is a schematic cross-sectional view showing a configuration of a cartridge according to an eighth embodiment.

FIG. 21 is a schematic cross-sectional view showing a configuration of a cartridge in a comparative example with respect to the cartridge according to the eighth embodiment.

FIG. 22 is a schematic cross-sectional view showing a configuration of a cartridge according to a ninth embodiment.

FIG. 23 is a schematic cross-sectional view showing a configuration of a cartridge according to a tenth embodiment.

FIG. 24 is a schematic cross-sectional view showing a configuration of a cartridge according to an eleventh embodiment.

FIG. 25 is a schematic front view showing a configuration of a cartridge according to a twelfth embodiment.

FIG. 26 is a schematic cross-sectional view for illustrating a configuration of an atmosphere valve according to the twelfth embodiment.

### DESCRIPTION OF EXEMPLARY EMBODIMENTS

### A. First Embodiment

Configuration of Printer

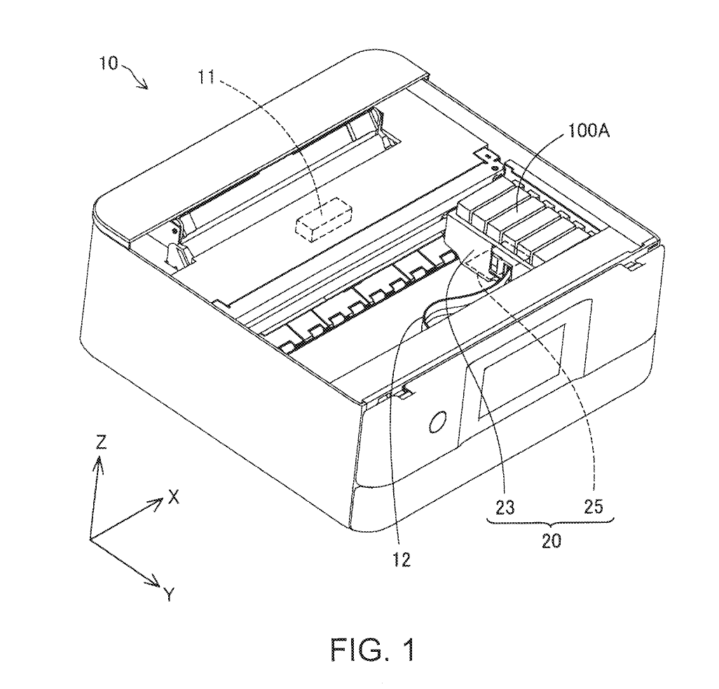

FIG. 1 is a schematic perspective view of a printer 10 in which ink cartridges 100A according to a first embodiment of the invention are mounted. In FIG. 1, arrows X, Y, and Z that indicate three orthogonal directions are shown. The arrow X indicates the left-right direction parallel to the lateral direction (width direction) of the printer 10, and indicates the direction from the left side to the right side when a user directly faces the printer 10. The arrow Y indicates a direction parallel to the front-rear direction of the printer 10, and indicates the direction from the rear side (back face side) to the front side (front face side). The arrow Z indicates the height direction of the printer 10, and indicates the vertically upward direction relative to an installation surface on which the printer 10 is installed. When the printer 10 is in its normal use state, the arrows X and Y indicate directions parallel to a horizontal plane, and the arrow Z indicates the direction opposite to the gravity direction (vertical direction). The arrows X, Y, and Z are also shown in correspondence with those in FIG. 1 as appropriate in other diagrams used in the description of this specification. In this specification, “up/above” and “down/below” mean directions based on the arrow Z direction. Similarly, “front” and “rear” mean directions based on the arrow Y direction, and “left” and “right” mean directions based on the arrow X direction.

The printer 10 is an inkjet printer of a so-called on-carriage type, and executes print processing for discharging ink supplied from a plurality of ink cartridges 100A mounted in a carriage 20 to form an image. In this embodiment, dye ink is contained in the ink cartridges 100A. The printer 10 is a specific concept of a liquid ejection apparatus according to the invention, and the ink cartridges 100A are each an embodiment of a liquid supply unit according to the invention. In the following description, the ink cartridges 100A will also be simply called “cartridges 100A”.

The printer 10 includes a control unit 11 in addition to the aforementioned carriage 20. The control unit 11 is constituted by a microcomputer having a central processing unit and a main storage device. The control unit 11 controls each constituent part of the printer 10 and executes print processing and the like by loading various commands and programs to the main storage device and executing them.

The carriage 20 is installed so as to move back and forth in the printer 10, and includes a holder 23 and a print head 25. The holder 23 is configured to enable the plurality of cartridges 100A to be mounted in parallel. In this embodiment, the cartridges 100A have a shape close to a flat, rectangular parallelepiped shape, and are mounted in the holder 23 while being arranged in a line in the arrow Y direction. A configuration of the holder 23 will be described later.

The print head 25 is provided in a lower face of the holder 23. The print head 25 is supplied with ink from the cartridges 100A mounted in the holder 23. The print head 25 includes an ink chamber that contains ink, and a nozzle provided in the ink chamber (not shown). When print processing is executed, the print head 25 discharges ink in the ink chamber from the nozzle based on a control signal from the control unit 11 using a known method, such as by applying pressure to the ink by using a piezoelectric element.

The printer 10 includes a carriage drive mechanism (not shown) for linearly moving the carriage 20 back and forth. The carriage drive mechanism includes a rail on which the carriage 20 moves, a motor that generates a driving force, and a pulley that transmits this driving force. The carriage drive mechanism moves the carriage 20 back and forth under the control of the control unit 11. The direction in which the carriage 20 moves back and forth is the main scanning direction of the printer 10. In this embodiment, the main scanning direction is a direction parallel to the arrow X direction, and is a direction perpendicular to the direction in which the cartridges 100A are arranged.

The control unit 11 and the carriage 20 are electrically connected via a flexible cable 12. The control unit 11 exchanges information regarding the ink, electrical signals indicating a mounting state of the cartridges 100A, and the like with a later-described board of each cartridge 100A via the flexible cable 12. The control unit 11 also transmits a control signal for controlling discharge of the ink to the print head 25 via the flexible cable 12.

The printer 10 also includes a conveyance mechanism (not shown) that conveys print media. The conveyance mechanism includes a conveyance motor and a conveyance roller, and is driven under the control of the control unit 11. In the printer 10, each print medium is conveyed in a direction substantially perpendicular to the main scanning direction below a conveyance path for the carriage 20 by the conveyance mechanism. The direction in which the print medium is conveyed below the conveyance path for the carriage 20 is the sub-scanning direction of the printer 10. In this embodiment, the sub-scanning direction is the arrow Y direction.

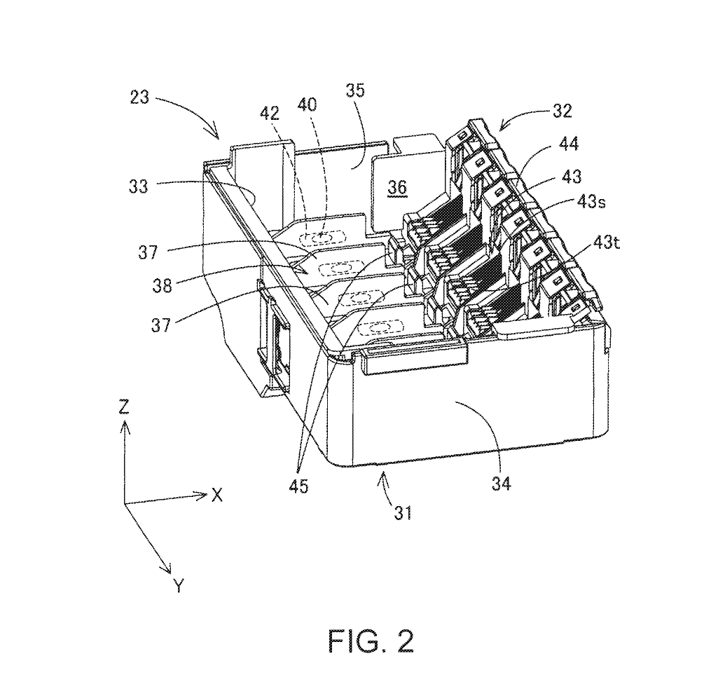

FIG. 2 is a schematic perspective view of the holder 23 provided in the carriage 20 as viewed obliquely from above. In this embodiment, in the holder 23, six types of cartridges 100A that contain ink of different colors are mounted one-by-one. More specifically, six cartridges 100A that contain ink of six colors, namely black, yellow, magenta, light magenta, cyan, and light cyan are mounted.

The holder 23 is configured to be a substantially rectangular parallelepiped box body that is open in the arrow Z direction, and has five walls 31, 32, 33, 34, and 35. The first wall 31 is a wall that constitutes a bottom face of the holder 23. In the following description, the first wall 31 will also be called a bottom wall 31. The other four walls 32 to 35 are walls that constitute side faces of the holder 23. The second wall 32 is arranged on the right face side in the printer 10, and the third wall 33 is arranged on the left face side in the printer 10. The fourth wall 34 is arranged on the front face side in the printer 10. The fifth wall 35 is arranged on the back face side in the printer 10. In the holder 23, a cartridge housing portion 36 in which the cartridges 100A are mounted is constituted by a recessed portion surrounded by these five walls 31 to 35.

The cartridge housing portion 36 is divided into a plurality of regions 38 capable of receiving the respective cartridges 100A, by a plurality of partition walls 37 parallel to the fourth wall 34 and the fifth wall 35. These regions 38 will be hereinafter called “slots 38”. The partition walls 37 function as guides when the cartridges 100A are inserted into the slots 38. A process of mounting the cartridges 100A into the holder 23 will be described after a configuration of the cartridges 100A is described.

The slots 38 are each provided with an ink introduction portion 40, an electrode portion 43, a lever 44, and a projection 45. The ink introduction portion 40 is formed as a substantially elliptic opening that is open in the arrow Z direction at a position sandwiched by two adjacent partition walls 37. The ink introduction portion 40 is connected to an ink supply portion of the corresponding cartridge 100A and receives ink supplied from the cartridge 100A. The ink in the cartridge 100A flows, via the ink introduction portion 40, into a flow path (not shown) formed in the holder 23, and is supplied to the ink chamber in the print head 25.

A seal 42 is provided at the periphery of the ink introduction portion 40. The seal 42 is made of elastic rubber, for example. When the cartridge 100A is mounted in the holder 23, the seal 42 comes into contact with an end face of a later-described outer peripheral wall of the cartridge 100A, and forms a seal line that surrounds the ink introduction portion 40. The seal 42 biases, in the arrow Z direction, the cartridge 100A mounted in the holder 23.

The electrode portion 43 is provided at a corner where the bottom wall 31 intersects the second wall 32, and has a terminal face 43s that faces obliquely upward. A plurality of terminals 43t are arranged on the terminal face 43s (FIG. 2). The terminals 43t project upward from the terminal face 43s, and each come into electrical contact with a corresponding terminal on the later-described board of the cartridge 100A. The terminals 43t are electrically connected to the flexible cable 12 of the printer 10.

The lever 44 is provided at an upper end of the second wall 32, and is located above the electrode portion 43. The lever 44 is provided so as to rotate in the direction opposite to the arrow X. The lever 44 rotates to the slot 38 sidem thereby engaging with a later-described fitting portion, which is provided as a projection on the cartridge 100A. In this specification, “to engage” means to engage with a part of or the entire object such that the moving direction of the object is limited. Note that, in the holder 23, in addition to the lever 44, a rib receiving portion (not shown), with which a later-described rib provided in the corresponding cartridge 100A is to engage, is formed in the third wall 33 as an engaging portion with which the cartridge 100A is to engage.

The projection 45 is provided on the bottom wall 31 so as to project in the arrow Z direction. As described later, the projection 45 fits to a positioning portion provided in the corresponding cartridge 100A, and restricts the movement of the cartridge 100A mounted in the holder 23.

Configuration of Cartridge

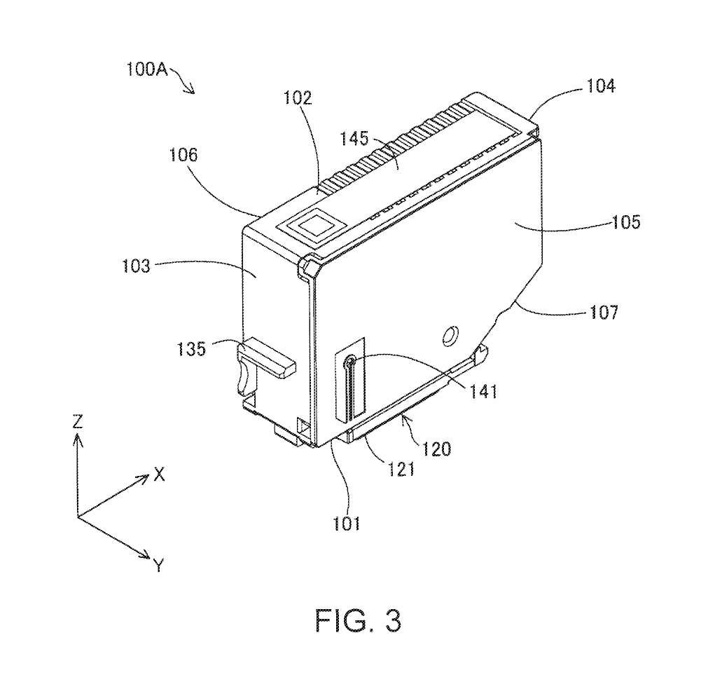

A configuration of the cartridge 100A will be described with reference to FIGS. 3 to 10. The cartridge 100A according to this embodiment is a so-called semi-closed ink cartridge, and has a configuration in which external air is intermittently introduced to the inside as the ink is consumed. A description will be given below of a configuration of the cartridge 100A in terms of its external appearance, an internal configuration thereof, and a mechanism for taking in the external air in the cartridge 100A in this order. Note that, hereinafter, a description regarding directions of the cartridge 100A are based on the posture of the cartridge 100A when mounted in the printer 10 in the normal use state.

Configuration of Cartridge in Terms of External Appearance

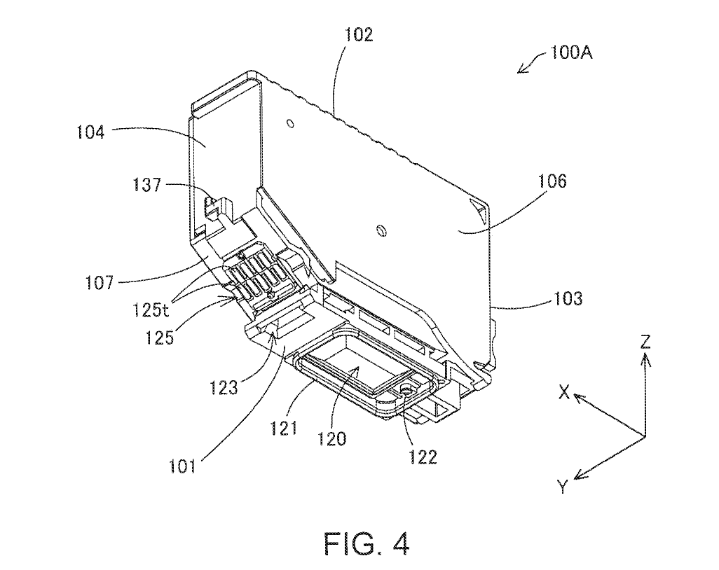

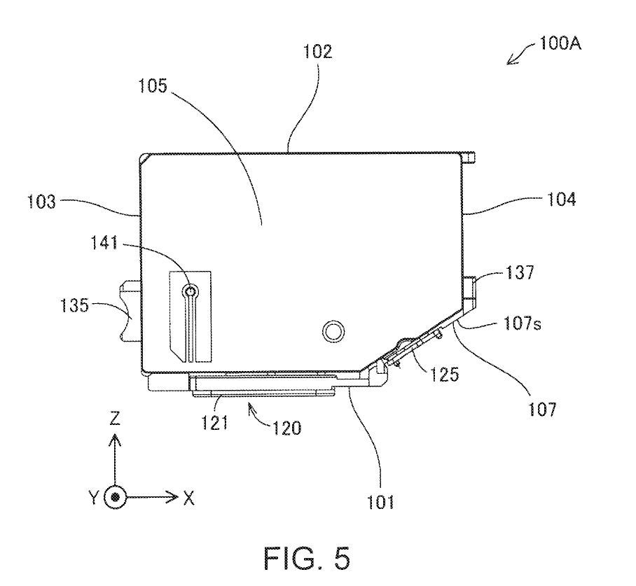

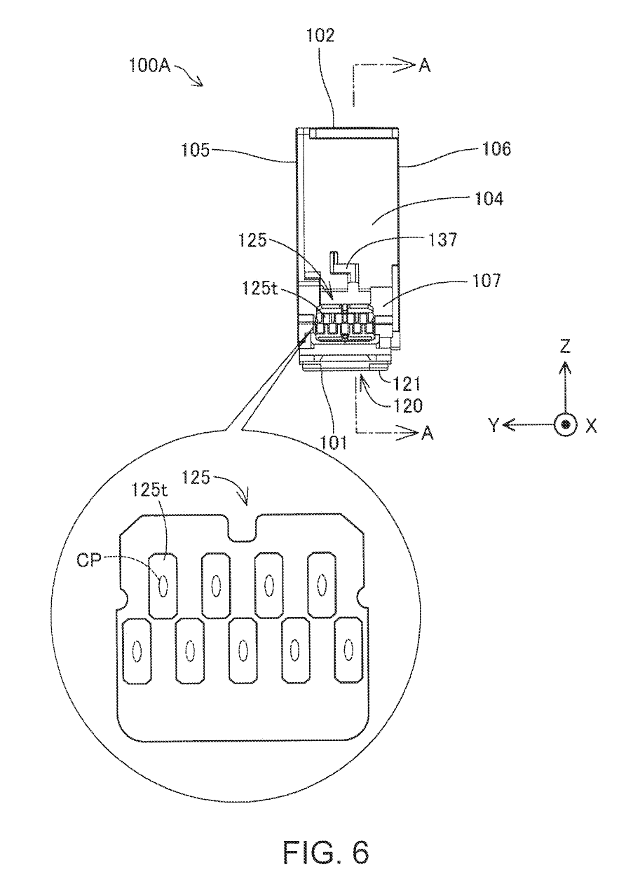

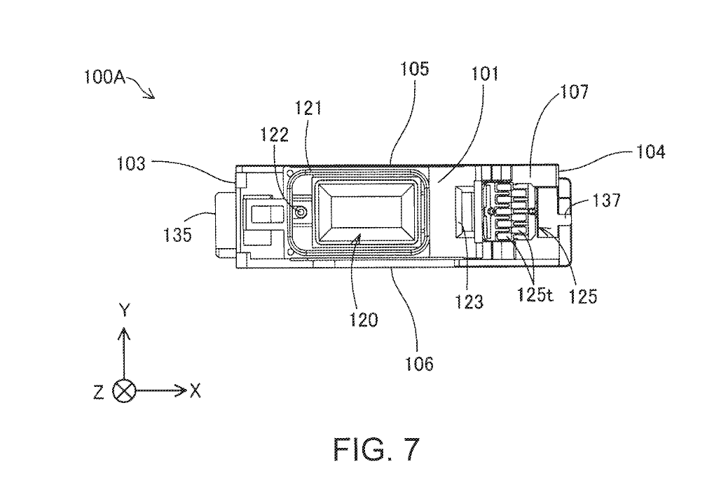

FIG. 3 is a schematic perspective view of the front face side of the cartridge 100A as viewed obliquely from above. FIG. 4 is a schematic perspective view of the back face side of the cartridge 100A as viewed obliquely from below. FIG. 5 is a schematic front view of the cartridge 100A. FIG. 6 is a schematic right side face view of the cartridge 100A. In FIG. 6, a board 125 of the cartridge 100A is shown in an enlarged manner in a balloon. FIG. 7 is a schematic bottom face view of the cartridge 100A.

The cartridge 100A has a substantially polyhedral shape constituted by seven walls 101 to 107 having a substantially rectangular shape (FIGS. 3 and 4). In this specification, “wall” is not limited to a flat wall, and may be curved, or may have a bent portion or a step, or may have, on its surface, a recess, a projection, a groove, an inclined face, or the like.

The first wall 101 is a wall that constitutes a bottom face of the cartridge 100A (FIGS. 4 and 7), and extends in two directions, namely the arrow X and Y directions. In this specification, “to extend” means a state of continuously stretching without a break in a certain direction. An extending state includes a state of extending in a certain direction and bending in the middle, and a curving state. The first wall 101 faces the bottom wall 31 of the holder 23 when the cartridge 100A is mounted in the carriage 20 in the printer 10.

The second wall 102 is a wall that constitutes an upper face of the cartridge 100A (FIG. 3), and extends in two directions, namely the arrow X and Y directions, at a position opposing the first wall 101. In this specification, the walls “opposing” each other means either a state where the walls directly face each other or a state where the walls indirectly face each other with another thing therebetween.

The third wall 103 is a wall that constitutes a left side face of the cartridge 100A (FIG. 3). The third wall 103 extends in two directions, namely the arrow Y and Z directions, between the first wall 101 and the second wall 102, and intersects the first wall 101 and the second wall 102. In this specification, two walls “intersecting” each other means any of a state where the two walls actually intersect each other, a state where one wall is located at a position in an extending direction of the other wall, and a state where the extending directions of the two walls intersect each other. Accordingly, a chamfered portion or the like that constitutes a curved face may be present between the walls that intersect each other.

The fourth wall 104 is a wall that, together with the seventh wall 107, constitutes a right side face of the cartridge 100A (FIGS. 4 and 6), and extends in two directions, namely the arrow Y and Z directions. The fourth wall 104 extends from the second wall 102 in the direction opposite to the arrow Z, intersects the first wall 101 and the second wall 102, and opposes the third wall 103.

The fifth wall 105 is a wall that constitutes a front face of the cartridge 100A (FIGS. 3 and 5), and extends in two directions, namely the arrow X and Z directions. The fifth wall 105 intersects the first wall 101, the second wall 102, the third wall 103, and the fourth wall 104. An outer peripheral outline of the fifth wall 105 as viewed in the arrow Y direction has a substantially rectangular shape from which a corner is cut out.

The sixth wall 106 is a wall that constitutes a back face of the cartridge 100A (FIG. 4), and extends in two directions, namely the arrow X and Z directions. The sixth wall 106 opposes the fifth wall 105, and intersects the first wall 101, the second wall 102, the third wall 103, and the fourth wall 104. The sixth wall 106 has substantially the same outer peripheral outline shape as that of the fifth wall 105.

The seventh wall 107 is a wall that, together with the fourth wall 104, constitutes a right side face of the cartridge 100A, and is located below the fourth wall 104 (FIG. 6). The seventh wall 107 obliquely extends between the first wall 101 and the fourth wall 104 (FIGS. 4 and 5), and intersects the fifth wall 105 and the sixth wall 106 (FIG. 6). In this embodiment, a lower end of the seventh wall 107 is coupled to the first wall 101.

When viewed in the arrow Z direction, the width of the cartridge 100A in the arrow Y direction is smaller than the width thereof in the arrow X direction (FIG. 7). As mentioned above, in the printer 10, the cartridges 100A are mounted in the carriage 20 such that their longitudinal direction in which the third wall 103 and the fourth wall 104 oppose each other coincides with the main scanning direction, and the cartridges 100A are arranged in the sub-scanning direction (FIG. 1). With this configuration, an increase in the size of the carriage 20 in the main scanning direction is suppressed, and the size of the printer 10 in the width direction can be reduced.

The first wall 101 is provided with an ink supply portion 120 for supplying ink in the cartridge 100 to the printer 10 (FIGS. 4 and 7). The ink supply portion 120 corresponds to a specific concept of a liquid supply portion according to the invention. The details of a configuration of the ink supply portion 120 will be described later. An outer peripheral wall 121 is provided at the outer periphery of the ink supply portion 120. A communication port 122 is provided on the left face side of the ink supply portion 120 in a region surrounded by the outer peripheral wall 121. Functions of the outer peripheral wall 121 and the communication port 122 will be described later.

The first wall 101 is also provided with a positioning portion 123 (FIGS. 4 and 7). In this embodiment, the positioning portion 123 is formed as a recess that is recessed in the arrow Z direction. When the cartridge 100A is mounted in the carriage in the printer, the projection 45 (FIG. 2) provided in the holder 23 in the carriage 20 is fitted to the positioning portion 123. Thus, the arrangement position and the arrangement posture of the cartridge 100A in the holder 23 are defined.

The board 125 is provided in the seventh wall 107 (FIGS. 4 to 7). The board 125 is arranged along an outer wall face 107s of the seventh wall 107, and faces obliquely downward (FIG. 5). The board 125 has a plurality of tabular terminals 125t (FIG. 6). In this embodiment, two lines of the plurality of terminals 125t are arranged above and below in parallel on a surface of the board 125. In each line, the plurality of terminals 125t are arranged in the arrow Y direction at given intervals. When the cartridge 100A is mounted in the carriage 20 in the printer 10, each terminal 125t is electrically connected to a corresponding one of the terminals 43t provided in the electrode portion 43 of the holder 23. In this specification, a part of the board 125 where the terminals 125t come into electrical contact with and are electrically connected to the terminals 43t on the printer 10 side will also be called a “contact portion CP”.

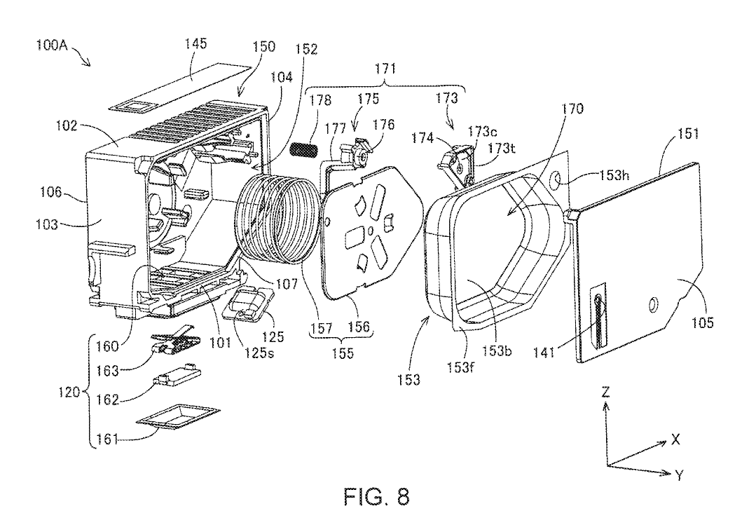

As mentioned above, the printer 10 exchanges, via the board 125, electrical signals indicating a mounting state of the cartridges 100A and information regarding ink, such as the color of the ink and the amount of remaining ink contained in the cartridges 100A. In this embodiment, the information regarding the ink is stored in a storage device 125s provided on the back face of the board 125. The storage device 125s is shown in FIG. 8, which will be referenced in a later description.

A rib 135 is provided in the third wall 103 (FIGS. 3 and 5). The rib 135 projects from a wall face of the third wall 103 in the direction opposite to the arrow X, and extends along the wall face of the third wall 103. The rib 135 engages with the later-described rib receiving portion, which is provided as a recess in the third wall 33 of the holder 23, and functions as an engaging portion that fixes the cartridge 100A to the holder 23.

A fitting portion 137 is provided in the fourth wall 104 (FIGS. 4 to 6). In this embodiment, the fitting portion 137 is configured to be a rib-like projection that projects from a wall face of the fourth wall 104 in the arrow X direction and extends on the wall face of the fourth wall 104. When the cartridge 100A is mounted in the holder 23 in the carriage 20, the fitting portion 137 engages with the lever 44 (FIG. 2) of the holder 23 while fitting thereto.

A ventilation hole 141 for introducing air into the cartridge 100A is formed in the fifth wall 105 (FIGS. 3 and 5). The ventilation hole 141 is a through hole that is in communication with the inside of the cartridge 100A. Air is introduced into the cartridge 100A via the ventilation hole 141 (details will be described later). A seal 145 is attached to the second wall 102 (FIG. 3). For example, the manufacturer and the model of the cartridge 100A are displayed on the seal 145. The seal 145 may be attached at any position, and may be attached to a wall other than the second wall 102. The seal 145 may be omitted.

Internal Configuration of Cartridge

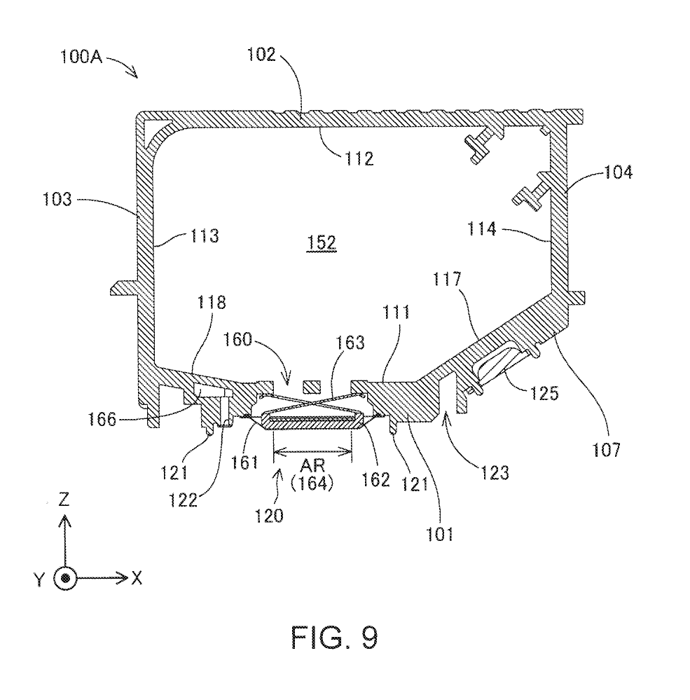

An internal structure of the cartridge 100A will be described with reference to FIGS. 8 and 9. FIG. 8 is an exploded schematic perspective view of the cartridge 100A. FIG. 9 is a schematic cross-sectional view of the cartridge 100A taken along arrows A-A shown in FIG. 6. In FIG. 9, a pressure adjustment mechanism 155 and an atmosphere valve 171, which will be described below, in an ink containing portion 152 are omitted for the sake of convenience.

The main body of the cartridge 100A is constituted by a body member 150 and a lid member 151 (FIG. 8). The body member 150 is a box-like member that is open in the arrow Y direction. An outer wall of the body member 150 constitutes the first wall 101, the second wall 102, the third wall 103, the fourth wall 104, the sixth wall 106, and the seventh wall 107 of the cartridge 100A.

The lid member 151 is a plate-like member. The lid member 151 is attached so as to close the opening of the body member 150 to constitute the fifth wall 105 of the cartridge 100A. The body member 150 and the lid member 151 are produced by means of injection molding of a synthetic resin such as polypropylene. The aforementioned board 125 and the seal 145 are attached to an outer wall face of the body member 150. The aforementioned ventilation hole 141 is formed in the lid member 151.

In the cartridge 100A, a space in a recess in the body member 150 constitutes the ink containing portion 152 that contains ink. The ink containing portion 152 corresponds to a specific concept of a liquid containing portion according to the invention.

Here, the ink containing portion 152 faces an inner wall face 111 of the first wall 101, an inner wall face 112 of the second wall 102, an inner wall face 113 of the third wall 103, an inner wall face 114 of the fourth wall 104, and an inner wall face 117 of the seventh wall 107 (FIG. 9). Among these inner wall faces 111, 112, 113, and 117, the inner wall face 117 of the seventh wall 107 inclines relative to the gravity direction (direction opposite to the arrow Z), and a lower end of the inner wall face 117 is located between the third wall 103 and the fourth wall 104 in the arrow X direction. In the following description, the inner wall face 117 will also be called an “inclined wall face 117”. In this embodiment, the lower end of the inclined wall face 117 is coupled to the first wall 101.

The inner wall face 111 of the first wall 101 that constitutes the bottom face of the ink containing portion 152 inclines at a corner position where the first wall 101 and the third wall 103 intersect each other. In the following description, the inclined wall face 117 of the seventh wall 107 will be called a “first inclined wall face 117”, and the inclined wall face formed in the inner wall face 111 of the first wall 101 will be called a “second inclined wall face 118” for the purpose of distinction. The second inclined wall face 118 inclines relative to the gravity direction such that a lower end thereof is located between the third wall 103 and the fourth wall 104 in the arrow X direction.

In the cartridge 100A, due to the provision of the aforementioned two inclined wall faces 117 and 118 in the ink containing portion 152, the occurrence of a failure in ink supply to the printer 10 is suppressed. A reason why the occurrence of an ink supply failure is suppressed by the two inclined wall faces 117 and 118 will be described later.

The ink containing portion 152 is closed on the fifth wall 105 side by a sheet member 153, which is arranged between the body member 150 and the lid member 151 (FIG. 8). The sheet member 153 is constituted by a flexible film-like resin member made of a synthetic resin that is a material including nylon and polypropylene, for example.

The sheet member 153 has an outer peripheral portion 153f and a main body 153b. The outer peripheral portion 153f is a frame-like tabular member, and is joined to the opening end portion of the body member 150 by means of welding or adhesion. A through hole 153h is formed in the outer peripheral portion 153f. An air chamber 170 and an air introduction port 174 are in communication with each other through the through hole 153h, as described later. The main body 153b is a main body part of the sheet member 153 surrounded by the outer peripheral portion 153f. The entire main body 153b projects from the outer peripheral portion 153f to the sixth wall 106 side, and forms a recess that is recessed in the direction opposite to the arrow Y. A space between the sheet member 153 and the fifth wall 105 functions as the air chamber 170 that contains air.

The ink containing portion 152 is provided with the pressure adjustment mechanism 155 for setting a given negative pressure state in the ink containing portion 152, when in a state where ink is contained therein. The pressure adjustment mechanism 155 includes a pressure receiving plate 156 and a biasing member 157. The pressure receiving plate 156 is a tabular plate-like member that is arranged in contact with the main body 153b of the sheet member 153 in the ink containing portion 152. The pressure receiving plate 156 is made of a synthetic resin such as polypropylene, or a metal such as stainless steel. The pressure receiving plate 156 has a shape that corresponds to a bottom face of the recess in the main body 153b of the sheet member 153, and is joined to this bottom face.

The biasing member 157 is constituted by a coil spring, for example. The biasing member 157 is arranged between the pressure receiving plate 156 and the sixth wall 106, and biases the pressure receiving plate 156 in the arrow Y direction that is a direction in which the volume of the ink containing portion 152 increases. In this embodiment, the biasing member 157 biases the pressure receiving plate 156 in the arrow Y direction. As a result of the pressure receiving plate 156 being pressed to the fifth wall 105 side by the biasing member 157, the sheet member 153 is caused to sag at the outer periphery of the pressure receiving plate 156, and the recess in the sheet member 153 enters a state of being collapsed to the fifth wall 105 side. Thus, when the ink containing portion 152 is filled with ink, the inside of the ink containing portion 152 is in the given negative pressure state.

The inner wall face 111 of the first wall 101 that constitutes the bottom face of the ink containing portion 152 is provided with an opening 160 for constituting the ink supply portion 120. The opening 160 is formed as a through hole that passes through the first wall 101 in the arrow Z direction at a substantially central position in the first wall 101. The ink supply portion 120 is configured as a result of a filter 161, a foam portion 162, and a flat spring portion 163 being attached to the opening 160 from below.

In the ink supply portion 120, the filter 161 is arranged so as to cover the opening 160, and is welded to the periphery of the opening 160 outside the cartridge 100A (FIG. 9). The filter 161 is constituted by a liquid-permeable film-like member through which ink can permeate. The filter 161 is made of woven fabric, non-woven fabric, or foamed resin (foam), for example.

The foam portion 162 is arranged on a face of the filter 161 on the ink containing portion 152 side. The foam portion 162 is constituted by a porous member, and is impregnated with the ink in the ink containing portion 152. The foam portion 162 supplies the ink to the filter 161 while diffusing the ink throughout itself. The foam portion 162 is made of a synthetic resin such as polyethylene terephthalate, for example.

The flat spring portion 163 is constituted by a metal plate, and is arranged between the ink containing portion 152 and the foam portion 162. The flat spring portion 163 has a shape in which two flat springs intersect each other. The flat spring portion 163 biases the filter 161 and the foam portion 162 in the direction opposite to the arrow Z as a result of an upper end of the flat spring portion 163 being arranged so as to engage with a step formed in the inner peripheral face of the opening 160, and a lower end coming into contact with the foam portion 162. The flat spring portion 163 has a shape that does not interrupt distribution of the ink from the opening 160 to the foam portion 162.

The filter 161 in the ink supply portion 120 comes into contact with the ink introduction portion 40 (FIG. 2) in the holder 23 in a contact region AR when the cartridge 100A is mounted in the carriage 20 in the printer 10. The ink in the ink containing portion 152 passes through the contact region AR of the filter 161 and is supplied to the printer 10. In this specification, the contact region AR through which the ink passes will also be called an “ink supply port 164”.

As mentioned above, when the cartridge 100A is mounted in the carriage 20, the outer peripheral wall 121 provided at the outer periphery of the ink supply portion 120 comes into contact with the seal 42 (FIG. 2) in the holder 23, and a seal line is formed at the outer periphery of the ink supply portion 120. The communication port 122 is formed together with the ink supply portion 120 in a closed space surrounded by this seal line, as mentioned above. The communication port 122 is in communication with the air chamber 170 (FIG. 8) via a communicating path 166 formed in the first wall 101. Thus, when the cartridge 100A is mounted in the carriage 20, a pressure difference between the closed space surrounded by the seal line and the outside is kept substantially constant. Therefore, ink leakage from the ink supply portion 120 due to a change in pressure within the closed space is suppressed.

Outside atmosphere is introduced into the air chamber 170 via the ventilation hole 141 in a ventilation portion 140 provided in the fifth wall 105. The cartridge 100A is provided with an atmosphere valve 171 for introducing the air in the air chamber 170 into the ink containing portion 152 as the ink in the ink containing portion 152 is consumed. The atmosphere valve 171 includes a valve seat 173, a valve member 175, and a coil spring 178.

The valve seat 173 is arranged at a corner where the second wall 102 and the fourth wall 104 of the ink containing portion 152 intersect each other, so as not to interfere with the pressure receiving plate 156. The valve seat 173 has a recess 173c on the sheet member 153 side, and an opening end face 173t of the recess 173c is airtightly stuck to a corner of the outer peripheral portion 153f of the sheet member 153. The recess 173c in the valve seat 173 is in communication with the through hole 153h in the sheet member 153. An air introduction port 174 that passes through the valve seat 173 in the arrow Y direction is formed at the bottom of the recess 173c in the valve seat 173. The valve seat 173 is made of a synthetic resin such as polypropylene, for example.

The valve member 175 has a valve 176 and a lever 177. The valve 176 is an end part of the valve member 175, and is arranged at a position opposing the air introduction port 174 in the valve seat 173. The lever 177 is an extension part that extends in a substantially L-shape from the valve 176. The lever 177 extends from the valve 176 in the direction opposite to the arrow Y, then bends, and extends to a position opposing the pressure receiving plate 156 in the arrow Y direction. The valve member 175 is attached such that the lever 177 can rotate about a fulcrum on the valve 176 side. The valve member 175 is made of a synthetic resin such as polypropylene, for example. The valve member 175 may be made by means of double-molding using an elastic member such as elastomer and a synthetic resin such as polypropylene.

The coil spring 178 is arranged between the valve 176 in the valve member 175 and the sixth wall 106, and biases the valve 176 so as to press the valve 176 against the air introduction port 174 in the valve seat 173. As a result of being biased by the coil spring 178, the valve 176 in the valve member 175 comes into contact with the peripheral portion of the air introduction port 174 in the valve seat 173 and airtightly closes the air introduction port 174.

Mechanism for Taking in Outside Air into Cartridge

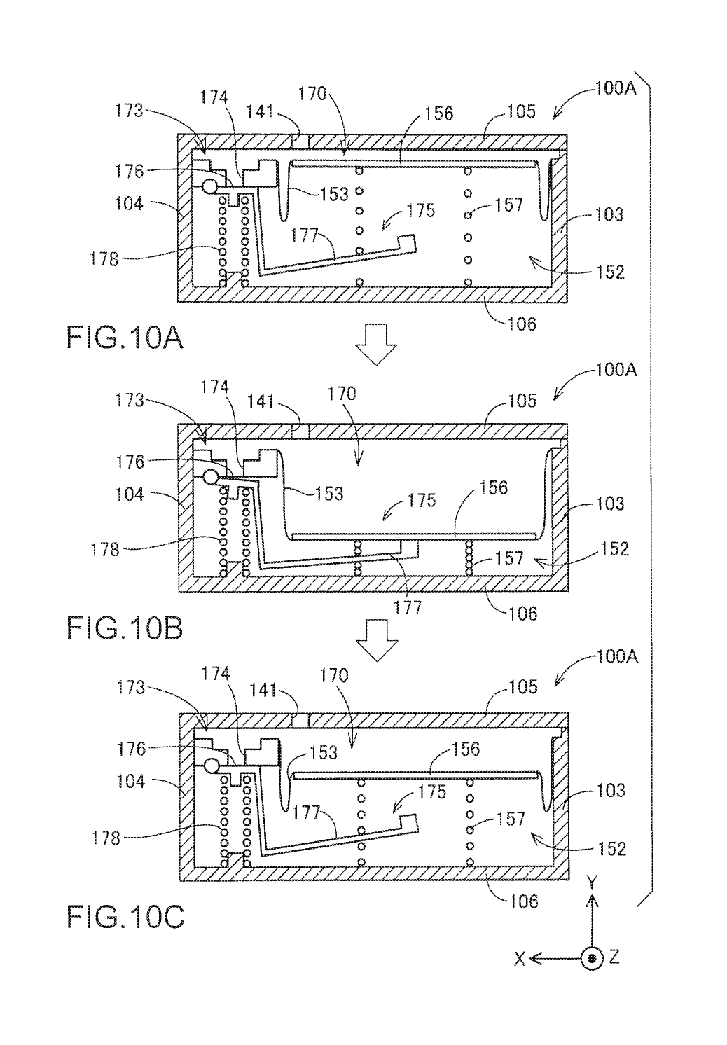

FIGS. 10A to 10C are schematic views for illustrating a mechanism by which outside air is taken into the cartridge 100A. FIGS. 10A to 10C schematically show an internal structure of the cartridge 100A as viewed in the direction opposite to the arrow Z. In FIGS. 10A to 10C, the ink supply portion 120 is omitted for the sake of convenience.

In a full state where a predetermined amount of ink is contained in the ink containing portion 152, the pressure receiving plate 156 is pressed toward the fifth wall 105 side by the biasing member 157, and a state where the volume of the ink containing portion 152 is expanded is entered (FIG. 10A), as mentioned above. At this time, the pressure receiving plate 156 is located at a position closest to the fifth wall 105. The inside of the ink containing portion 152 is in the given negative pressure state, and a part of the sheet member 153 is drawn into the ink containing portion 152 at the outer periphery of the pressure receiving plate 156. In addition, in this state, the air introduction port 174 in the valve seat 173 is closed by the valve 176 in the valve member 175, and the ink containing portion 152 is airtightly sealed against the air chamber 170. The lever 177 in the valve member 175 is located at a position separate from the pressure receiving plate 156.

As the ink is supplied to the printer 10 from the ink supply portion 120 via the opening 160 and the ink in the ink containing portion 152 is consumed, the pressure difference between the air chamber 170 and the ink containing portion 152 increases, and the pressure receiving plate 156 moves toward the sixth wall 106 side (FIG. 10B). Upon the pressure receiving plate 156 reaching the position of the leading end of the lever 177 in the valve member 175 and pressing the lever 177, the valve member 175 rotates, the sealed state of the air introduction port 174 that has been achieved by the valve 176 is cancelled, and the atmosphere valve 171 enters an open state. Thus, the air in the air chamber 170 is introduced into the ink containing portion 152, and the air outside the cartridge 100A is introduced into the air chamber 170 via the ventilation hole 141.

As the air is introduced into the ink containing portion 152 and the pressure difference between the air chamber 170 and the ink containing portion 152 is reduced, the pressure receiving plate 156 moves toward the fifth wall 105 side due to the biasing force of the biasing member 157 (FIG. 100). Upon the pressure receiving plate 156 separating from the lever 177 in the valve member 175, the air introduction port 174 is again sealed by the valve 176 by the biasing force of the coil spring 178, and the atmosphere valve 171 is restored to a closed state.

Thus, in the cartridge 100A, the atmosphere valve 171 temporarily enters an open state when the negative pressure in the ink containing portion 152 increases with consumption of the ink in the ink containing portion 152. Then, the air is introduced into the ink containing portion 152, and the atmosphere valve 171 is again restored to a closed state when the ink containing portion 152 enters an appropriate negative pressure state. Since the pressure in the ink containing portion 152 is thus kept within an appropriate pressure range, the occurrence of an ink supply failure due to an excessive increase in the negative pressure in the ink containing portion 152 is suppressed.

The cartridge 100A according to this embodiment is mounted in the carriage 20 such that the direction (arrow Y direction) in which the biasing member 157 biases the pressure receiving plate 156 is a direction perpendicular to the main scanning direction in the printer 10 (FIG. 1). For this reason, the biasing force of the biasing member 157 applied to the pressure receiving plate 156 being affected by the inertia force in a direction parallel to the main scanning direction that is generated by the back-and-forth movement of the carriage 20 when the printer 10 executes printing is suppressed. Accordingly, with the cartridge 100A, a change in pressure in the ink containing portion 152 due to the back-and-forth movement of the carriage 20 is suppressed, and the occurrence of an ink supply failure is suppressed. In the cartridge 100A according to this embodiment, the moving direction of the valve 176 (arrow Y direction), which is a direction in which the valve 176 is biased by the coil spring 178, intersects the main scanning direction in the printer 10. Therefore, the biasing force of the coil spring 178 applied to the valve 176 being affected by the aforementioned inertia force is suppressed, and the valve 176 opening the air introduction port 174 due to this inertia force is suppressed. Accordingly, the occurrence of an unexpected pressure change in the ink containing portion 152 is suppressed, and the occurrence of a failure in the supply of ink IK is suppressed.

Process of Mounting Cartridge into Carriage

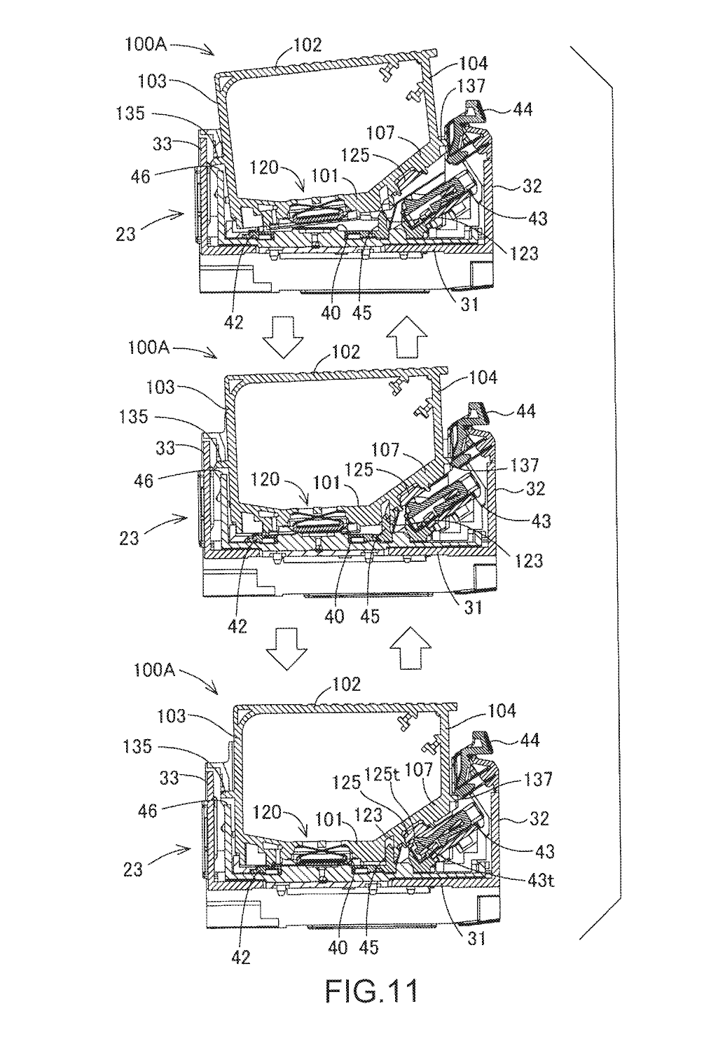

FIG. 11 is a schematic view showing a process of mounting the cartridge 100A into the holder 23 in the carriage 20. FIG. 11 shows the process of mounting the cartridge 100A into the holder 23 in order from the top, middle, and bottom. In FIG. 11, the cartridge 100A and the holder 23 are shown in their schematic cross-section taken at the same cross-sectional position as in FIG. 9. Note that, regarding the cartridge 100A, the pressure adjustment mechanism 155 and the atmosphere valve 171 are omitted for the sake of convenience, similar to FIG. 9.

When the cartridge 100A is mounted into the holder 23, initially, the rib 135 on the cartridge 100A is inserted into a rib receiving portion 46, which is formed as a recess in the third wall 33 of the holder 23 (upper part of FIG. 11). Then, the seventh wall 107 side of the cartridge 100A is rotated downward with a part where the rib 135 and the rib receiving portion 46 are in contact and engage with each other as a fulcrum, and the terminals 125t on the board 125 are brought into contact with the corresponding terminals 43t on the electrode portion 43 while causing the projection 45 to fit to the positioning portion 123 (middle part in FIG. 11). Thereafter, the lever 44 is rotated toward the cartridge 100A, and is engaged with the fitting portion 137 of the cartridge 100A (lower part of FIG. 11).

In this embodiment, the board 125 in the cartridge 100A is arranged so as to incline along the outer wall face of the seventh wall 107 that inclines relative to the arrow Z direction. Therefore, in the process of mounting the cartridge 100A, the board 125 is pressed toward the electrode portion 43 on the holder 23, and the electrical contact performance between the board 125 and the electrode portion 43 is enhanced. In this embodiment, when the board 125 is pressed toward the electrode portion 43 on the holder 23, the terminals 125t on the board 125 are rubbed by the leading ends of the corresponding terminals 43t on the electrode portion 43. For this reason, stains or the like on the terminals 125t on the board 125 are removed, and therefore, the electrical contact performance between the board 125 and the electrode portion 43 is further enhanced.

The movement of the cartridge 100A in the arrow Z direction is restricted in the holder 23 as a result of the rib 135 on the third wall 103 engaging with the rib receiving portion 46, and the fitting portion 137 on the fourth wall 104 engaging with the lever 44. The movement in a direction parallel to the arrow X is also restricted as a result of the projection 45 fitting to the positioning portion 123 in the first wall 101. Note that the process of removing the cartridge 100A from the holder 23 is a process in the reverse order of the above mounting process.

Effect of Suppressing Ink Supply Failure Achieved by Inclined Wall Faces

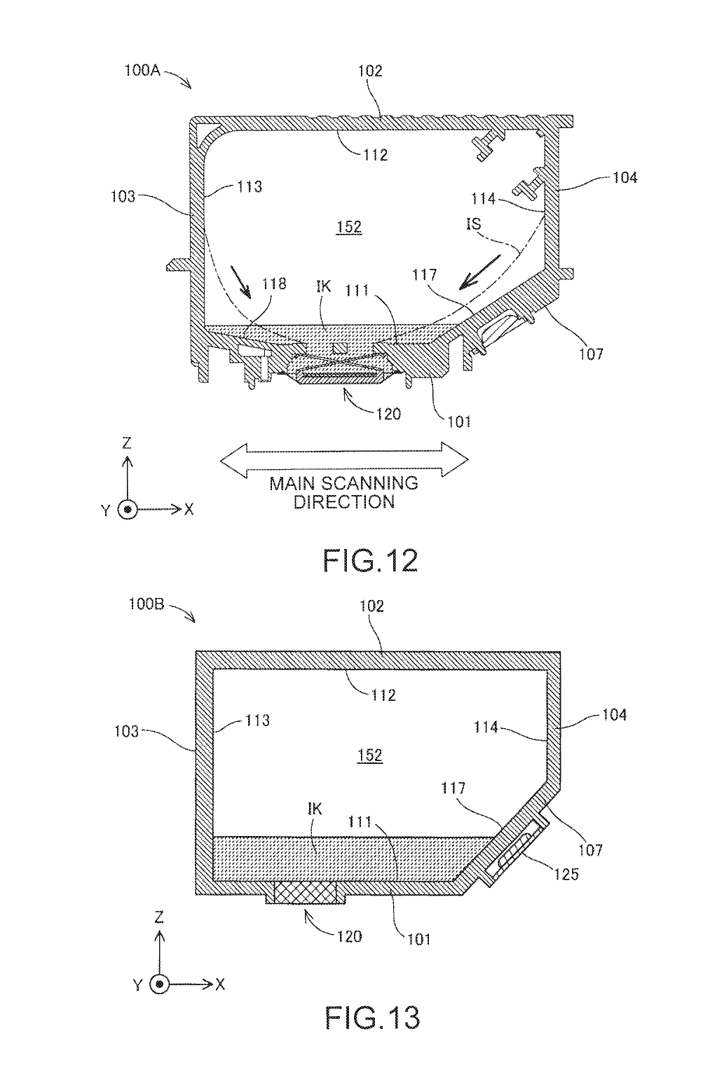

FIG. 12 is a schematic view for illustrating an effect of suppressing an ink supply failure achieved by the two inclined wall faces 117 and 118 provided in the cartridge 100A. FIG. 12 shows a schematic cross-section of the cartridge 100A similar to that in FIG. 9. Also, FIG. 12 schematically shows a state where the ink IK is contained in the ink containing portion 152, and schematically shows an exemplary position of a liquid surface IS of the ink IK when the ink IK swings in the ink containing portion 152, with alternate long and short dash lines.

In the cartridge 100A, the ink supply portion 120 is sandwiched by the first inclined wall face 117 and the second inclined wall face 118, and is formed in a part where the ink IK gathers. Therefore, the performance of ink supply from the ink supply portion 120 is enhanced. Also, the occurrence of a failure in the supply of the ink IK from the cartridge 100A when the printer 10 executes printing is suppressed as follows.

As mentioned above, the cartridge 100A is mounted into the holder 23 in the carriage 20 such that the longitudinal direction of the cartridge 100A that is the direction in which the third wall 33 and the forth face 34 face each other, is parallel to the main scanning direction of the printer 10. As mentioned above, the carriage 20 moves in the main scanning direction during print processing. When the carriage 20 scans, the carriage 20 performs movement such as acceleration, deceleration, and inversion of its moving direction. For this reason, when print processing is executed by the printer 10, inertia force is generated in the ink IK in the ink containing portion 152 when the carriage 20 accelerates, decelerates, or inverts its moving direction, for example, and the ink IK greatly swings in the ink containing portion 152.

Here, in this specification, “swing” of liquid such as the ink IK means movement of the liquid whose liquid surface undulates in accordance with a change in the direction or the magnitude of the external force received by the liquid. The swing of the ink IK caused by the movement of the carriage 20 in this embodiment mainly means a waving movement of the liquid surface of the ink IK caused as a result of the gravity position of the ink IK in the ink containing portion 152 moving in the main scanning direction due to the inertia force generated in the ink IK by the aforementioned movement of the carriage 20.

In the cartridge 100A, the ink IK that has moved upward unevenly to the fourth wall 104 side due to inertia force in a direction parallel to the arrow X direction is quickly and smoothly guided toward the ink supply portion 120 by the first inclined wall face 117 of the seventh wall 107. Similarly, on the third wall 103 side, the ink IK that has been unevenly distributed to the third wall 103 side due to inertia force in a direction parallel to the direction opposite to the arrow X is quickly and smoothly guided toward the ink supply portion 120 by the second inclined wall face 118 provided in the first wall 101. Accordingly, the ink IK separating from the ink supply portion 120 is suppressed, and interruption of the outflow of the ink IK is suppressed. Accordingly, the occurrence of a failure in the supply of the ink IK from the cartridge 100A to the printer 10 is suppressed.

In particular, in this embodiment, the lower end of the seventh wall 107 is coupled to the first wall 101, the first inclined wall face 117 is continuous with the inner wall face 111 of the first wall 101, and the second inclined wall face 118 is also formed as a part of the inner wall face 111 of the first wall 101. With this configuration, the distances between the respective inclined wall faces 117 and 118 and the ink supply portion 120 are shortened. Therefore, a higher effect can be achieved.

### Summary of First Embodiment

As described above, with the cartridge 100A according to the first embodiment, the occurrence of a failure in the supply of the ink IK due to swinging of the ink IK in the ink containing portion 152 caused when the printer 10 executes printing is suppressed. In addition, with the cartridge 100A according to the first embodiment, various effects mentioned in the above description can be achieved.

### B. Second Embodiment

FIG. 13 is a schematic cross-sectional view showing a configuration of a cartridge 100B according to a second embodiment of the invention. In FIG. 13, a configuration of the ink containing portion 152 and the ink supply portion 120 provided in the cartridge 100B according to the second embodiment is schematically shown, and the pressure adjustment mechanism 155 and the atmosphere valve 171 in the ink containing portion 152 are omitted for the sake of convenience.

The cartridge 100B according to the second embodiment has a configuration that is substantially similar to that of the cartridge 100A according to the first embodiment, except that the inner wall face 111 of the first wall 101 does not have the second inclined wall face 118 and is configured to be substantially flat. The cartridge 100B according to the second embodiment is mounted in a printer having a configuration similar to that of the printer 10 described in the first embodiment.

With the cartridge 100B according to the second embodiment, the ink IK that has been unevenly distributed to the fourth wall 104 side when the printer executes printing is quickly and smoothly guided to the ink supply portion 120 by the seventh wall 107 having the inclined wall face 117. Accordingly, the occurrence of a failure in the supply of the ink IK from the cartridge 100A to the printer 10 is suppressed. In addition, with the cartridge 100B according to the second embodiment, various effects described in the first embodiment can be achieved.

### C. Third Embodiment

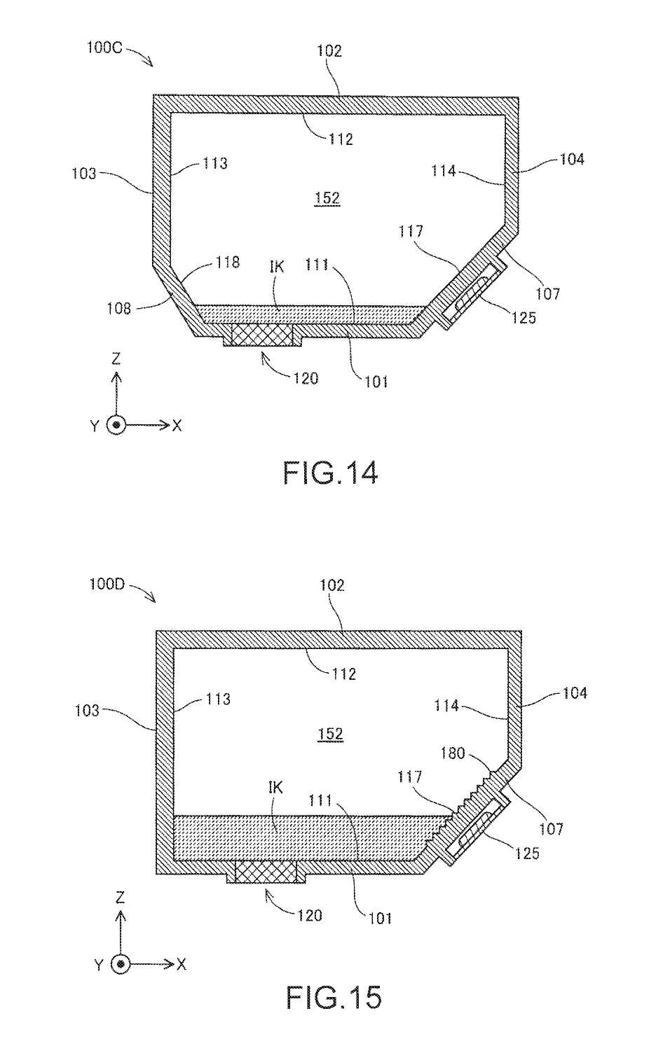

FIG. 14 is a schematic cross-sectional view showing a configuration of a cartridge 100C according to a third embodiment of the invention. In FIG. 14, a configuration of the ink containing portion 152 and the ink supply portion 120 provided in the cartridge 100C according to the third embodiment is schematically shown, and the pressure adjustment mechanism 155 and the atmosphere valve 171 in the ink containing portion 152 are omitted for the sake of convenience. The cartridge 100C according to the third embodiment has a configuration that is substantially similar to that of the cartridge 100A according to the first embodiment except for the following points, and is mounted in a printer having a configuration similar to that of the printer 10 described in the first embodiment.

In the cartridge 100C according to the third embodiment, an eighth wall 108 is provided between the first wall 101 and the third wall 103. The eighth wall 108 intersects the fifth wall 105 and the sixth wall 106, and inclines relative to the gravity direction such that a lower end of the eighth wall 108 is located between the third wall 103 and the fourth wall 104. In the cartridge 100C according to the third embodiment, the second inclined wall face 118 is formed as not a part of the inner wall face 111 of the first wall 101 but an inner wall face of the eighth wall 108.

With the cartridge 100C according to the third embodiment as well, similar to the cartridge 100A according to first embodiment, the occurrence of a failure in the supply of the ink IK due to swinging of the ink IK in the ink containing portion 152 when the printer executes printing is suppressed. In addition, with the cartridge 100C according to the third embodiment, various effects described in the above embodiments can be achieved.

### D. Fourth Embodiment

FIG. 15 is a schematic cross-sectional view showing a configuration of a cartridge 100D according to a fourth embodiment of the invention. In FIG. 15, a configuration of the ink containing portion 152 and the ink supply portion 120 provided in the cartridge 100D according to the fourth embodiment is schematically shown, and the pressure adjustment mechanism 155 and the atmosphere valve 171 in the ink containing portion 152 are omitted for the sake of convenience. The cartridge 100D according to the fourth embodiment has a configuration that is substantially similar to that of the cartridge 1006 (FIG. 13) according to the second embodiment except for the following points, and is mounted in a printer having a configuration similar to that of the printer 10 described in the first embodiment.

In the cartridge 100D according to the fourth embodiment, a plurality of projections 180 that project toward the ink containing portion 152 are provided on the inclined wall face 117 of the seventh wall 107. The plurality of projections 180 are formed in a minutely and closely dispersed manner on the inclined wall face 117, and leading edges of the projections 180 are pointed. With the cartridge 100D according to the fourth embodiment, even if the inertia force in a direction parallel to the arrow X direction is generated in the ink IK by the movement of the carriage 20, the ink IK moving upward along the inclined wall face 117 is suppressed by the recess-and-projection structure of the inclined wall face 117. Accordingly, the occurrence of a failure of the supply of the ink IK from the cartridge 100A to the printer 10 due to swinging of the ink IK in the ink containing portion 152 caused by the movement of the carriage 20 is suppressed.

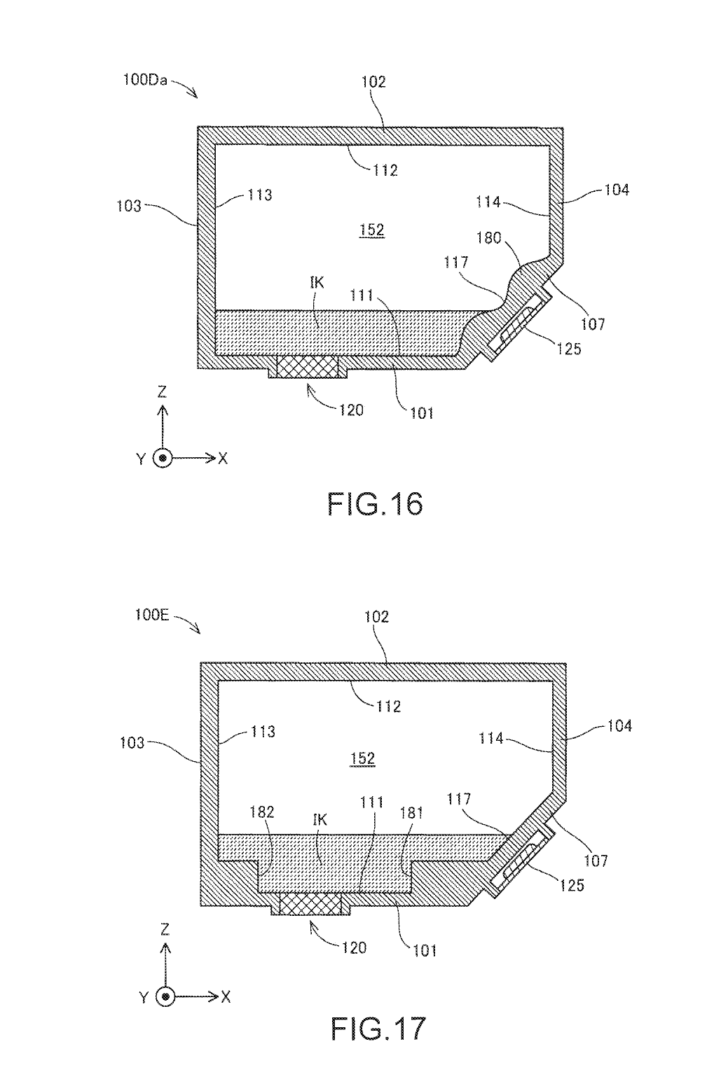

FIG. 16 is a schematic cross-sectional view showing a cartridge 100Da, which is another exemplary configuration according to the fourth embodiment. In the cartridge 100Da, the plurality of projections 180 are each configured to have a swollen shape having a gently curved face. With this configuration as well, a recess-and-projection structure is formed on the inclined wall face 117. Therefore, effects similar to those of the cartridge 100D described in FIG. 15 can be achieved.

As described above, with the cartridges 100D and 100Da according to the fourth embodiment, the occurrence of a failure in the supply of the ink IK due to swinging of the ink IK in the ink containing portion 152 is further suppressed by the recess-and-projection structure on the inclined wall face 117. In addition, with the cartridges 100D and 100Da according to the fourth embodiment, various effects described in the above embodiments can be achieved.

### E. Fifth Embodiment

FIG. 17 is a schematic cross-sectional view showing a configuration of a cartridge 100E according to a fifth embodiment of the invention. In FIG. 17, a configuration of the ink containing portion 152 and the ink supply portion 120 provided in the cartridge 100E according to the fifth embodiment is schematically shown, and the pressure adjustment mechanism 155 and the atmosphere valve 171 in the ink containing portion 152 are omitted for the sake of convenience. The cartridge 100E according to the fifth embodiment has a configuration that is substantially similar to that of the cartridge 100B according to the second embodiment except for the following points, and is mounted in a printer having a configuration similar to that of the printer 10 described in the first embodiment.

In the cartridge 100E according to the fifth embodiment, two steps 181 and 182 are provided in the inner wall face 111 of the first wall 101. The first step 181 is provided at a corner where the seventh wall 107 and the first wall 101 intersect, so as to protrude upward in a step-like manner from a part where the ink supply portion 120 is provided. The second step 182 is provided at a corner where the third wall 103 and the first wall 101 intersect, so as to protrude upward in a step-like manner from a part where the ink supply portion 120 is provided. In the ink containing portion 152 in the cartridge 100E according to the fifth embodiment, the ink supply portion 120 is located in a recessed portion sandwiched by the two steps 181 and 182 in the arrow X direction.

With the cartridge 100E according to the fifth embodiment, even if the carriage 20 repeats the back-and-forth movement, movement of the ink IK existing on the ink supply portion 120, in a direction parallel to the arrow X is stopped by the two steps 181 and 182. Accordingly, the ink IK ceasing to be above the ink supply portion 120 is suppressed, and the occurrence of a failure of the supply of the ink IK from the cartridge 100E when the printer 10 executes printing is suppressed. In addition, with the cartridge 100E according to the fifth embodiment, various effects similar to those described in the above embodiments can be achieved.

### F. Sixth Embodiment

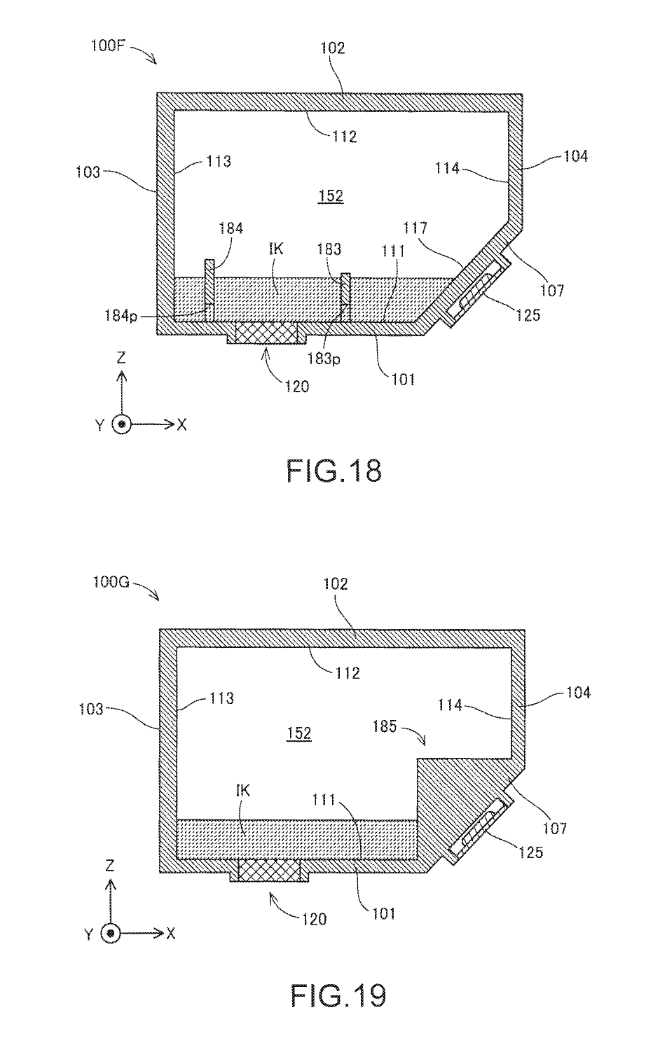

FIG. 18 is a schematic cross-sectional view showing a configuration of a cartridge 100F according to a sixth embodiment of the invention. In FIG. 18, a configuration of the ink containing portion 152 and the ink supply portion 120 provided in the cartridge 100F according to the sixth embodiment is schematically shown, and the pressure adjustment mechanism 155 and the atmosphere valve 171 in the ink containing portion 152 are omitted for the sake of convenience. The cartridge 100F according to the sixth embodiment is substantially the same as the cartridge 100F according to the fifth embodiment, except that two damming walls 183 and 184 are provided in place of the two steps 181 and 182.

The two damming walls 183 and 184 are walls parallel to the third wall 103 and the fourth wall 104, extend in the arrow Z direction from the inner wall face 111 of the first wall 101, and are formed so as to sandwich the ink supply portion 120 in the arrow X direction. The first damming wall 183 is provided between the seventh wall 107 and the ink supply portion 120, and the second damming wall 184 is provided between the third wall 103 and the ink supply portion 120. Communicating paths 183p and 184p, which are through holes, are provided at lower ends of the damming walls 183 and 184 such that the movement of the ink IK toward the ink supply portion 120 is not interrupted. Note that the damming walls 183 and 184 need only be located on respective sides of the ink supply portion 120 in the arrow X direction, and may not extend spanning the entirety of the ink containing portion 152 in the arrow Y direction.

With the cartridge 100F according to the sixth embodiment, the ink IK swinging so as to separate from the ink supply portion 120 as a result of the inertia force in a direction parallel to the arrow X direction generated by the movement of the carriage 20 is suppressed by the two damming walls 183 and 184. Accordingly, the occurrence of a failure in the supply of the ink IK from the cartridge 100F when the printer 10 executes printing is suppressed. In addition, with the cartridge 100F according to the sixth embodiment, various effects similar to those described in the above embodiments can be achieved.

### G. Seventh Embodiment

FIG. 19 is a schematic cross-sectional view showing a configuration of a cartridge 1000 according to a seventh embodiment of the invention. In FIG. 19, a configuration of the ink containing portion 152 and the ink supply portion 120 provided in the cartridge 100G according to the seventh embodiment is schematically shown, and the pressure adjustment mechanism 155 and the atmosphere valve 171 in the ink containing portion 152 are omitted for the sake of convenience. The cartridge 1000 according to the seventh embodiment has a configuration that is substantially similar to that of the cartridge 100B according to the second embodiment except for the following points, and is mounted in a printer having a configuration similar to that of the printer 10 described in the first embodiment.

In the cartridge 100G according to the seventh embodiment, the seventh wall 107 has a protruding portion 185 in place of the inclined wall face 117. The protruding portion 185 is a part of a wall face of the seventh wall 107 on the ink containing portion 152 side, the part protruding in the ink containing portion 152. The protruding portion 185 has two wall faces 185a and 185b that face the ink containing portion 152. The first wall face 185a is a wall face that intersects a lower end of the inner wall face 114 of the fourth wall 104 and extends in the direction opposite to the arrow X. The second wall face 185b is a wall face that bends from an end of the first wall face 185a, extends in the direction opposite to the arrow Z, and then intersects the inner wall face 111 of the first wall 101. In the cartridge 1000 according to the seventh embodiment, a region that is located above the protruding portion 185 and has a large width in the arrow X direction, and a region that is located adjacent to the protruding portion 185 in the arrow X direction and has a small width in the arrow X direction are formed in the ink containing portion 152.

With the cartridge 100G according to the seventh embodiment, the ink IK moving up to the fourth wall 104 due to the inertia force in a direction parallel to the arrow X direction generated by the movement of the carriage 20 is suppressed by a step formed by the protruding portion 185. Accordingly, the occurrence of a failure in the supply of the ink IK from the cartridge 100G when the printer 10 executes printing is suppressed. In addition, with the cartridge 100G according to the seventh embodiment, various effects similar to those described in the above embodiments can be achieved.

### H. Eighth Embodiment

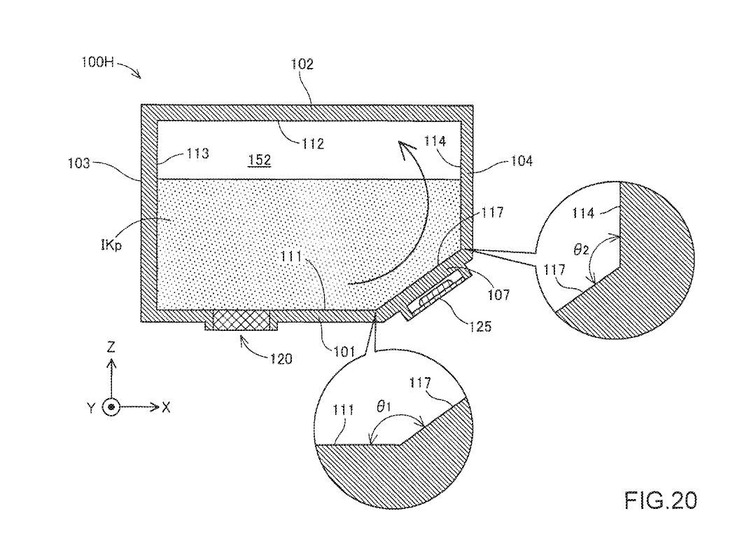

FIG. 20 is a schematic cross-sectional view showing a configuration of a cartridge 100H according to an eighth embodiment of the invention. In FIG. 20, a configuration of the ink containing portion 152 and the ink supply portion 120 provided in the cartridge 100H according to the eighth embodiment is schematically shown, and the pressure adjustment mechanism 155 and the atmosphere valve 171 in the ink containing portion 152 are omitted for the sake of convenience. In FIG. 20, a corner between the first wall 101 and the seventh wall 107 and a corner between the fourth wall 104 and the seventh wall 107 are shown in an enlarged manner in respective balloons.

The cartridge 100H according to the eighth embodiment contains ink IKp, which is pigment ink, in place of the ink IK, which is dye ink. The pigment ink is a specific concept of a dispersion liquid according to the invention. A printer in which the cartridge 100H according to the eighth embodiment is mounted has a configuration similar to that of the printer 10 described in the first embodiment, except that the printer has been modified as appropriate so as to be able to use pigment ink for printing.

With the cartridge 100H according to the eighth embodiment, when the ink IKp moves toward the fourth wall 104 side due to the inertia force in the arrow X direction generated by movement of the carriage 20, the ink IKp is guided upward by the inclined wall face 117. Therefore, a stirring force in the ink containing portion 152 is increased while the carriage 20 repeats the back-and-forth movement, and the dispersibility of the pigment, which contains insoluble particles in the ink IKp, increases.

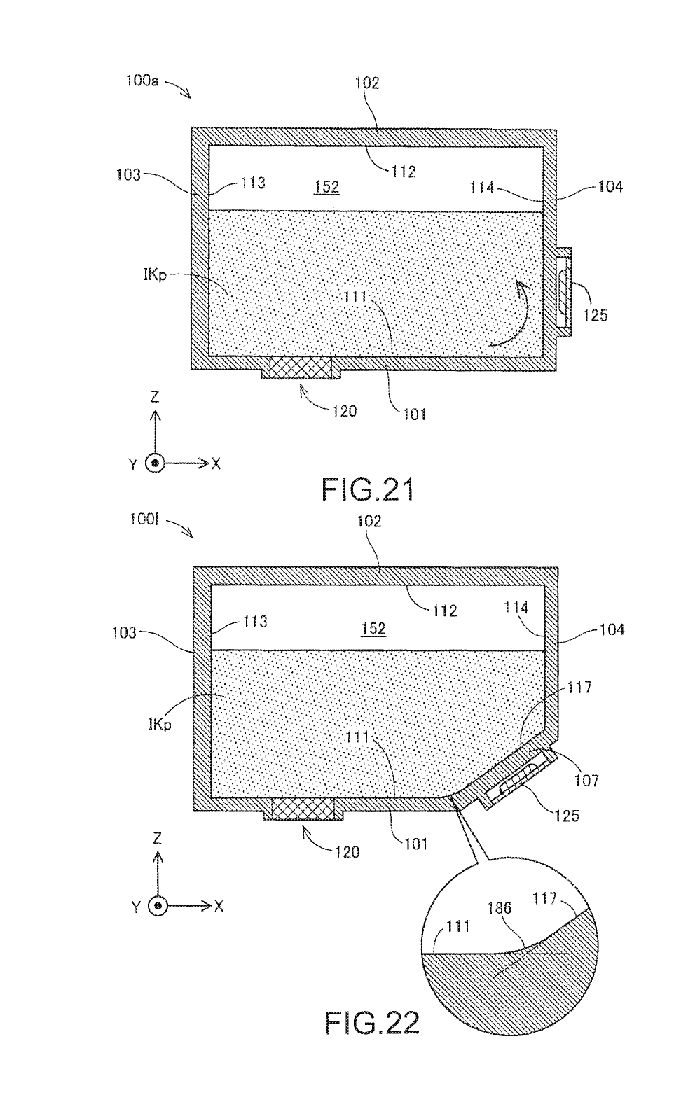

FIG. 21 is a schematic cross-sectional view showing a configuration of a cartridge 100a, which serves as a comparative example for the cartridge 100H according to the eighth embodiment. The configuration of the cartridge 100a in the comparative example is substantially the same as that of the cartridge 100H according to the eighth embodiment, except that the seventh wall 107 is omitted, and the fourth wall 104 substantially vertically intersects and is coupled to the first wall 101. In the cartridge 100a in the comparative example, the ink IKp that has moved in the arrow X direction due to inertia force collides with the inner wall face 114 of the fourth wall 104 and jumps back upon receiving a force of reaction in the direction opposite to the arrow X. For this reason, such a stirring force as in the cartridge 100H according to the eighth embodiment cannot be obtained.

In the cartridge 100H according to the eighth embodiment, an angle θ1 between the inclined wall face 117 of the seventh wall 107 and the inner wall face 111 of the first wall 101 on the ink containing portion 152 side is larger than an angle θ2 between the inner wall face 114 of the fourth wall 104 and the inclined wall face 117 of the seventh wall 107 on the ink containing portion 152 side (FIG. 20). With this configuration, in the cartridge 100H according to the eighth embodiment, the inclination angle of the inclined wall face 117 relative to the horizontal plane is gentle. For this reason, it is possible to reduce the force of reaction received from the inclined wall face 117 by the ink IKp that has moved upon receiving inertia force in the arrow X direction, to more smoothly guide this ink IKp upward, and to further increase the stirring force in the ink containing portion 152. To further increase the stirring force in the ink containing portion 152, it is favorable that the aforementioned angle θ1 is 110° or greater and 150° or smaller. It is more favorable that the angle θ1 is 130° or greater and 140° or smaller.

As described above, with the cartridge 100H according to the eighth embodiment, the force of stirring the ink IKp in the ink containing portion 152 can be increased. Therefore, the dispersibility of the pigment in the ink IKp can be enhanced. Also, with the cartridge 100H according to the eighth embodiment, the ink IKp that has been unevenly distributed to the fourth wall 104 side due to inertia force in the arrow X direction can be quickly guided toward the ink supply portion 120 by the inclined wall face 117. Accordingly, the occurrence of a failure in the supply of the ink IKp when the printer 10 executes printing can be suppressed, similar to the cartridges 100A to 100G in the above-described embodiments. In addition, with the cartridge 100H according to the eighth embodiment, various effects similar to those described in the above embodiments can be achieved.

### I. Ninth Embodiment

FIG. 22 is a schematic cross-sectional view showing a configuration of a cartridge 100I according to a ninth embodiment of the invention. In FIG. 22, a configuration of the ink containing portion 152 and the ink supply portion 120 provided in the cartridge 100I according to the ninth embodiment is schematically shown, and the pressure adjustment mechanism 155 and the atmosphere valve 171 in the ink containing portion 152 are omitted for the sake of convenience. The cartridge 100I according to the ninth embodiment has a configuration that is substantially similar to that of the cartridge 100H according to the eighth embodiment, except for the following points.

In the cartridge 100I according to the ninth embodiment, a curved face 186 is formed by rounding out a corner where the inclined wall face 117 of the seventh wall 107 and the inner wall face 111 of the first wall 101 intersect each other. The curved face 186 forms a curve that is convex downward as viewed in the arrow Y direction. With the cartridge 100I according to the ninth embodiment, the force of reaction received from the inclined wall face 117 by the ink IKp that is moving upon receiving inertia force in the arrow X direction is further reduced by the curved face 186, and the stirring force in the ink containing portion 152 is further increased. Accordingly, the dispersibility of the pigment in the ink IKp is enhanced. In addition, with the cartridge 100I according to the ninth embodiment, various effects similar to those described in the above embodiments can be achieved.

### J. Tenth Embodiment

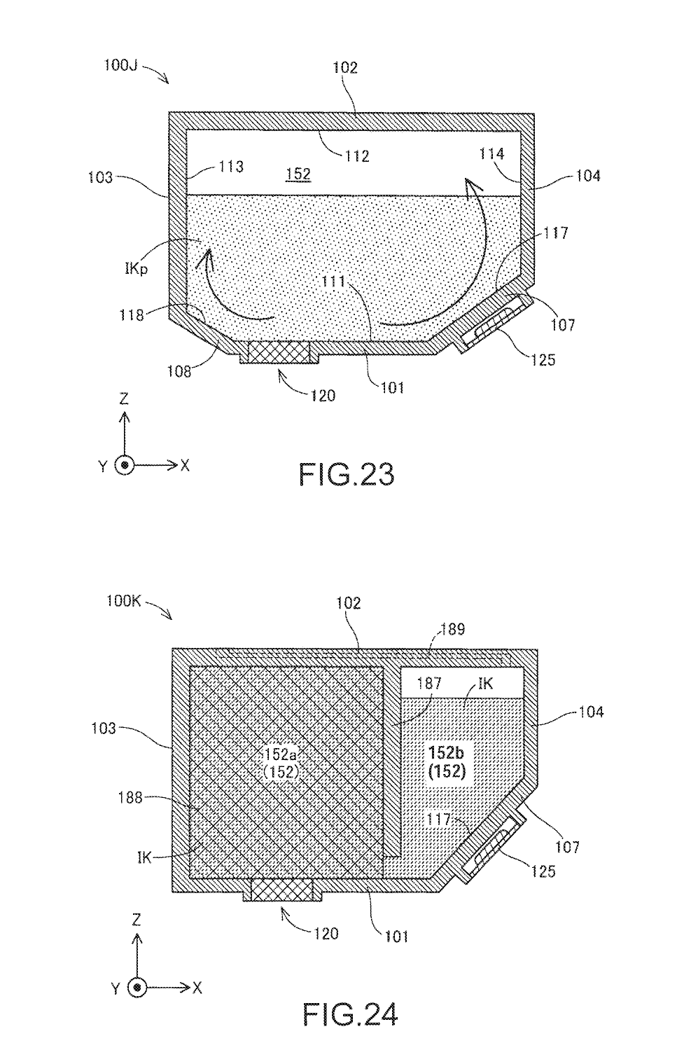

FIG. 23 is a schematic cross-sectional view showing a configuration of a cartridge 100J according to a tenth embodiment of the invention. In FIG. 23, a configuration of the ink containing portion 152 and the ink supply portion 120 provided in the cartridge 100J according to the tenth embodiment is schematically shown, and the pressure adjustment mechanism 155 and the atmosphere valve 171 in the ink containing portion 152 are omitted for the sake of convenience.

The configuration of the cartridge 100J according to the tenth embodiment is substantially the same as that of the cartridge 100H (FIG. 21) according to the eighth embodiment, except that the eighth wall 108 similar to that in the cartridge 100C (FIG. 14) according to the third embodiment is provided. Note that the angle between the second inclined wall face 118 of the eighth wall 108 and the inner wall face 111 of the first wall 101 on the ink containing portion 152 side is an angle in a preferable range of the aforementioned angle θ1 between the first inclined wall face 117 and the inner wall face 111 of the first wall 101 on the ink containing portion 152 side.

With the cartridge 100J according to the tenth embodiment, the force of stirring the ink IKp is also increased on the third wall 103 side by the second inclined wall face 118. Accordingly, the dispersibility of the pigment in the ink IKp is further increased. In addition, with the cartridge 100J according to the tenth embodiment, various effects similar to those described in the above embodiments can be achieved.

### K. Eleventh Embodiment

FIG. 24 is a schematic cross-sectional view showing a configuration of a cartridge 100K according to an eleventh embodiment of the invention. FIG. 24 schematically shows a configuration of the ink containing portion 152 and the ink supply portion 120 that are provided in the cartridge 100K according to the eleventh embodiment. The configuration of the cartridge 100K according to the eleventh embodiment is substantially the same as the cartridge 1006 according to the second embodiment, except for the following points.

The cartridge 100K according to the eleventh embodiment does not have the sheet member 153, the pressure adjustment mechanism 155, the atmosphere valve 171, and the ventilation hole 141 in the fifth wall 105. The entire internal space surrounded by the seventh walls 101 to 107 constitutes the ink containing portion 152. In the cartridge 100K according to the eleventh embodiment, the ink containing portion 152 is partitioned into two regions 152a and 152b by a partition wall 187.

The partition wall 187 is suspended from the second wall 102, and extends up to a position close to the first wall 101. The partition wall 187 is located between the ink supply portion 120 and the inclined wall face 117 in the arrow X direction. The partition wall 187 extends in the arrow Y direction, and is coupled to the fifth wall 105 and the sixth wall 106.

The first region 152a is located between the partition wall 187 and the third wall 103. The ink supply portion 120 is provided in the first region 152a. An ink holding member 188 is housed in the first region 152a. The ink holding member 188 faces the ink supply portion 120. The ink holding member 188 is constituted by a porous member that includes fine spaces capable of causing a capillary force with respect to a liquid, such as a fibrous member formed by making polypropylene or a foamed member such as polyurethane foam into a fibrous state and bundling it. The ink holding member 188 can be impregnated with the ink IK.

The second region 152b is located between the partition wall 187 and the fourth wall 104. The second region 152b is a hollow region. The ink IK therein has a liquid surface, and is contained in an entirely swingable state without being subject to a capillary force or the like. As mentioned above, the lower end of the partition wall 187 is not coupled to the first wall 101, and the first region 152a and the second region 152b are in communication with each other below the lower end of the partition wall 187. For this reason, in the cartridge 100K, the ink IK in the second region 152b can flow into the first region 152a.

In the cartridge 100K according to the eleventh embodiment, an atmosphere passage 189, through which atmosphere is distributed, is provided inside the second wall 102. The atmosphere passage 189 is open to the outside above the first region 152a such that the outside air can be taken in. The atmosphere passage 189 is connected to the upper part of the second region 152b such that the outside atmosphere that has been taken in is introduced into the second region 152b.

With the cartridge 100K according to the eleventh embodiment, an interruption of inflow of the ink IK to the ink supply portion 120 is suppressed as a result of the ink holding member 188 being arranged in the first region 152a. Furthermore, as a result of providing the inclined wall face 117 in the second region 152b, inflow of the ink IK to the first region 152a being disturbed by swinging of the ink IK caused by the back-and-forth movement of the carriage 20 is suppressed.

As described above, with the cartridge 100K according to the eleventh embodiment, the performance of the supply of the ink IK to the printer 10 is increased as a result of the ink containing portion 152 being divided into the two regions 152a and 152b. In addition, with the cartridge 100K according to the eleventh embodiment, various effects described in the above embodiments can be achieved. Note that the ink IKp, which is pigment ink, may be contained in place of the ink IK, which is dye ink, in the cartridge 100K according to the eleventh embodiment. In this case, in the second region 152b of the ink containing portion 152, the dispersibility of the pigment in the ink IKp can be improved similarly as described in the eighth embodiment.

### L. Twelfth Embodiment

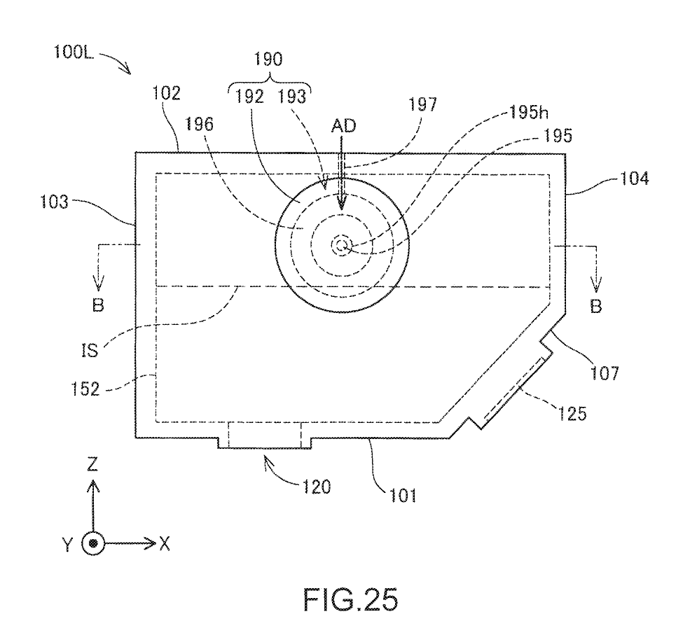

FIG. 25 is a schematic front view showing a configuration of a cartridge 100L according to a twelfth embodiment of the invention. In FIG. 25, the ink containing portion 152 formed within the cartridge 100L according to the twelfth embodiment and the liquid surface IS of the ink IK contained in the ink containing portion 152 are indicated by broken lines. The configuration of the cartridge 100L according to the twelfth embodiment is substantially the same as that of the cartridge 100B according to the second embodiment, except for the following points.

In the cartridge 100L according to the twelfth embodiment, the entire internal space surrounded by the seventh walls 101 to 107 constitutes the ink containing portion 152 similarly as in the cartridge 100K (FIG. 24) according to the eleventh embodiment. In the cartridge 100L according to the twelfth embodiment, an atmosphere valve 190, which intermittently introduces the outside air to the ink containing portion 152, is provided in the fifth wall 105.

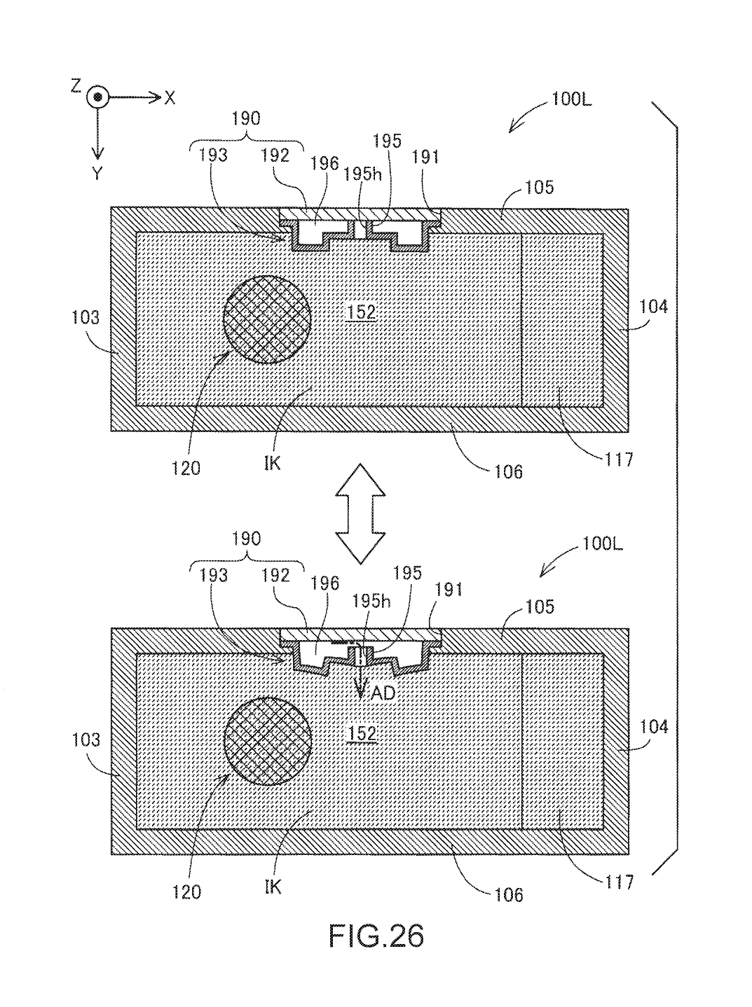

FIG. 26 is a schematic cross-sectional view for illustrating a configuration of the atmosphere valve 190 provided in the cartridge 100L according to the twelfth embodiment. The upper and lower parts of FIG. 26 show schematic cross-sections of the cartridge 100L taken along arrows B-B shown in FIG. 25. The upper part of FIG. 26 shows a state where the atmosphere valve 190 is closed, and the lower part shows a state where the atmosphere valve 190 is open.

In the cartridge 100L, a through hole 191 for forming the atmosphere valve 190 is provided at a position in the fifth wall 105 closer to the second wall 102 side (FIG. 26). The through hole 191 is in communication with the ink containing portion 152. The atmosphere valve 190 has a valve seat 192 and a valve member 193 (FIGS. 25 and 26).

The valve seat 192, which is a disk-like member, is attached to the through hole 191 from the outside of the cartridge 100L, and also functions as a lid member that closes the through hole 191 (FIG. 25). The valve seat 192 is produced by means of injection molding of a synthetic resin such as polypropylene.

The valve member 193 is constituted by a film-like member having a substantially disk-like shape that is formed with a flexible resin member (FIGS. 25 and 26). For example, the valve member 193 is made of an elastic material such as an elastomer. The valve member 193 has a valve 195, which is a cylindrical projection, at the center. The valve member 193 also has, around the valve 195, a groove-like recess 196 that is recessed in the direction opposite to the projecting direction of the valve 195.

The valve member 193 is held between the ink containing portion 152 and the valve seat 192 as a result of the entire outer inner circumferential portion of the valve member 193 engaging with a step formed over an inner circumferential face of the through hole 191. The valve member 193 is arranged so as to face the valve seat 192, on the side where the valve 195 projects. An air introduction port 195h, which is a through hole provided at the center of the valve 195, is airtightly closed by the valve seat 192. An opening of the groove-like recess 196 formed around the valve 195 is also airtightly closed by the valve seat 192.

In the cartridge 100L, an atmosphere communication path 197 is formed inside the fifth wall 105 so as to be able to introduce the outside air to the space between the groove-like recess 196 and the valve seat 192 (FIG. 25). The atmosphere communication path 197 extends upward from the space within the groove-like recess 196 in the atmosphere valve 190, and is open to the outside at an end on the second wall 102 side.

When the pressure in the ink containing portion 152 is in a given appropriate range, the valve 195 comes into close contact with the valve seat 192, and the air introduction port 195h is sealed airtightly. As a result, the distribution of air to the ink containing portion 152 is interrupted (upper part of FIG. 26). After the ink IK in the ink containing portion 152 has been consumed and the pressure in the ink containing portion 152 has become a negative pressure, the valve member 193 is suctioned to the ink containing portion 152 side and droops, and the valve 195 separates from the valve seat 192 (lower part of FIG. 26).

Thus, the air introduction port 195h in the valve 195 is released, and the outside air is introduced into the ink containing portion 152 via the atmosphere communication path 197, the groove-like recess 196, and the air introduction port 195h, as indicated by an arrow AD in FIGS. 25 and 26. Upon the pressure in the ink containing portion 152 being restored to the pressure in the given appropriate range, the valve 195 again comes into close contact with the valve seat 192, and the ink containing portion 152 is restored to a sealed state (upper part of FIG. 26).

Here, when the cartridge 100L is mounted in the carriage 20, the direction in which the valve 195 in the valve member 193 moves is a direction perpendicular to the main scanning direction. Accordingly, in the cartridge 100L, the valve 195 in the atmosphere valve 190 separating from the valve seat 192 due to inertia force generated when the carriage 20 repeats the back-and-forth movement is suppressed. Accordingly, the occurrence of an unexpected pressure change in the ink containing portion 152 due to the back-and-forth movement of the carriage 20 is suppressed, and the occurrence of a failure in the supply of the ink IK caused by such a pressure change is suppressed.

As described above, with the cartridge 100L according to the twelfth embodiment, the occurrence of an unexpected pressure change in the ink containing portion 152 while printing is executed is suppressed. In addition, with the cartridge 100L according to the twelfth embodiment, various effects described in the above embodiments can be achieved.

### M. Modifications

The configurations described in the above embodiments can be modified as in the following modifications. Note that, in the following modifications, the cartridges 100A to 100L described in the above embodiments will be referred to collectively as a “cartridge 100” unless stated otherwise.

### M1. Modification 1

The cartridges 100A to 100J according to the above first to tenth embodiments are each configured to be a semi-closed cartridge having the pressure adjustment mechanism 155 and the atmosphere valve 171. In contrast, the cartridges 100A to 100J according to the above first to tenth embodiments each may not be configured to be a semi-closed cartridge, and may not have the pressure adjustment mechanism 155 or the atmosphere valve 171. A configuration in which the outside air is introduced into the ink containing portion 152 via the atmosphere passage 189 described in the eleventh embodiment may be applied to the cartridges 100A to 100J.

### M2. Modification 2

In the above embodiments, in the cartridge 100, the board 125 is attached to the seventh wall 107. In contrast, the board 125 may be attached to a wall other than the seventh wall 107, or may be omitted. In the cartridge 100, a terminal that is electrically connected, in place of the board 125, to the printer may be directly arranged on a wall face of the cartridge 100. Alternatively, the board 125 may not be configured to exchange electrical signals indicating information regarding the ink with the printer 10, and may be configured to only be able to be electrically connected to the printer 10.

### M3. Modification 3

The configurations in the above embodiments can be combined as appropriate. For example, the projections 180 described in the fourth embodiment may be applied to the cartridge 100I according to the ninth embodiment. The configuration of the atmosphere valve 190 provided in the cartridge 100L according to the twelfth embodiment may be applied to the cartridges 100A to 100K according to the first to eleventh embodiments. Alternatively, in the cartridges 100A to 1000 according to the first to seventh embodiments, the ink IKp, which is pigment ink, may be contained in place of the ink IK, which is dye ink, as in the eighth embodiment.

### M4. Modification 4

In the above embodiments, the cartridge 100 is configured to be attached to and removed from the carriage 20, while the ink IK or IKp is contained in the cartridge 100. In contrast, the cartridge 100 may be configured to be mounted in the carriage 20 without the ink IK or IKp contained in the cartridge 100, and receive the ink IK or IKp injected to the ink containing portion 152 from the outside via a tube or the like when printing is executed or before printing is executed.

### M5. Modification 5

In the above embodiments, the cartridge 100 is mounted in a printer having the carriage 20 that moves back and forth in the arrow X direction. In contrast, the cartridge 100 may be mounted in a plotter having a carriage configured to be able to move in the arrow Y direction as well as the arrow X direction. The configuration of the cartridge 100 according to the above embodiments may be applied to a liquid supply unit that is mounted in a carriage in a liquid ejection apparatus other than an inkjet printer. For example, the configuration may be applied to a detergent supply unit for containing liquid detergent.

The invention is not limited to the above embodiments, examples, and modifications, and can be achieved in various configurations without departing from the gist of the invention. For example, the technical features in the embodiments, examples, and modifications corresponding to the technical features in the modes described in the summary of the invention may be replaced or combined as appropriate, in order to solve a part of or the entire problem described above, or to achieve some or all of the effects described above. The technical features that are not described as essential in this specification may be removed as appropriate.

The entire disclosure of Japanese Patent Application No. 2015-231544, filed Nov. 27, 2015, is expressly incorporated by reference herein.

What is claimed is:

1. A liquid supply unit that is to be mounted in a carriage configured to move back and forth in a liquid ejection apparatus, the liquid supply unit comprising:
a liquid containing portion that contains liquid to be supplied to the liquid ejection apparatus;
a liquid supply portion for supplying the liquid in the liquid containing portion to the liquid ejection apparatus; and
a plurality of walls that surround the liquid containing portion,
the plurality of walls including at least:
a first wall provided with the liquid supply portion;
a second wall that opposes the first wall;
a third wall that intersects the first wall and the second wall;
a fourth wall that intersects the second wall and opposes the third wall;
a fifth wall that intersects the first wall, the second wall, the third wall, and the fourth wall;
a sixth wall that intersects the first wall, the second wall, the third wall, and the fourth wall, and opposes the fifth wall; and
a seventh wall that intersects the fifth wall and the sixth wall, and is located between the first wall and the fourth wall,
wherein when the liquid supply unit is mounted in the carriage, a direction from the third wall toward the fourth wall is a direction parallel to a moving direction in which the carriage moves back and forth, and
when the liquid supply unit is mounted in the carriage, the seventh wall inclines relative to a gravity direction such that a lower end of the seventh wall is located between the third wall and the fourth wall in the moving direction.

2. The liquid supply unit according to claim 1,
wherein the lower end of the seventh wall is coupled to the first wall.

3. The liquid supply unit according to claim 1,
wherein an inclined inner wall face that inclines relative to the gravity direction is provided at a corner of the liquid containing portion at which the first wall and the third wall intersect each other, such that a lower end of the inclined inner wall face is located between the third wall and the fourth wall in the moving direction when the liquid supply unit is mounted in the carriage.

4. The liquid supply unit according to claim 1,
wherein a recess and a projection are formed on an inner wall face of the seventh wall on the liquid containing portion side.

5. The liquid supply unit according to claim 1,
wherein the seventh wall has an inclined wall face that is an inner wall face on the liquid containing portion side,
when the liquid supply unit is mounted in the carriage, the inclined wall face inclines relative to the gravity direction such that a lower end of the inclined wall face is located between the third wall and the fourth wall in the moving direction,
the liquid is dispersion liquid in which particles that are insoluble in a solvent are dispersed, and
the liquid containing portion has a region that faces the seventh wall and in which the dispersion liquid is contained in a swingable state.

6. The liquid supply unit according to claim 5,
wherein the first wall has a bottom wall face that faces the liquid containing portion, and
the inclined wall face and the bottom wall face intersect each other via a curved face that is formed by rounding out a corner where the inclined wall face and the bottom wall face intersect each other.

7. The liquid supply unit according to claim 5,
wherein the first wall has a bottom wall face that faces the liquid containing portion,
the fourth wall has a side wall face that faces the liquid containing portion, and
an angle between the bottom wall face and the inclined wall face on the liquid containing portion side is larger than an angle between the side wall face and the inclined wall face on the liquid containing portion side.

8. The liquid supply unit according to claim 5,
wherein the first wall has a bottom wall face that faces the liquid containing portion, and
an angle between the bottom wall face and the inclined wall face on the liquid containing portion side is 110° or greater and 150° or smaller.

9. The liquid supply unit according to claim 8,
wherein an angle between the first wall and the seventh wall on the liquid containing portion side is 130° or greater and 140° or smaller.

10. The liquid supply unit according to claim 1,
wherein a contact portion that comes into electrical contact with an electrode portion in the liquid ejection apparatus is arranged on an outer wall face of the seventh wall.

11. The liquid supply unit according to claim 1, further comprising:
a flexible film member located between the fifth wall and the sixth wall;
a plate-like member that is located between the fifth wall and the flexible film member to constitute a part of an inner wall face of the liquid containing portion, and is held by the flexible film member so as to be displaced between the fifth wall and the sixth wall in a direction in which the fifth wall and the sixth wall oppose each other, in accordance with internal pressure in the liquid containing portion; and
a biasing member that is arranged in the liquid containing portion and biases the plate-like member in a direction from the fifth wall toward the sixth wall.

12. The liquid supply unit according to claim 1, further comprising:
a partition wall that is provided between the third wall and the fourth wall, and partitions the liquid containing portion into a first region located on the third wall side and including the liquid supply portion, and a second region located on the fourth wall side and facing the seventh wall,
wherein the first region and the second region are in communication with each other,
a liquid containing member that is impregnated with the liquid is arranged in the first region, and
the liquid is contained in a swingable state in the second region.

13. The liquid supply unit according to claim 1, further comprising:
an atmosphere introduction portion that introduces outside atmosphere into the liquid containing portion,
wherein the atmosphere introduction portion has an atmosphere path through which the atmosphere is distributed, and an atmosphere valve that opens and closes the atmosphere path in accordance with pressure in the liquid containing portion,
the atmosphere valve has a valve seat and a valve member,
the valve member has a valve that moves to a position at which the valve abuts against the valve seat and a position at which the valve is separate from the valve seat,
the valve member is configured such that the valve abuts against the valve seat to close the atmosphere path when the pressure in the liquid containing portion is greater than or equal to a given pressure, and the valve separates from the valve seat to open the atmosphere path when the pressure in the liquid containing portion has become lower than the given pressure, and
a moving direction of the valve is a direction parallel to a direction from the fifth wall toward the sixth wall.
